(19) United States
(12) Patent Application Publication
(10) Pub. No.: US 2023/0403101 A1
(43) Pub. Date: Dec. 14, 2023

(54) METHODS TO COMPUTE A SIGNAL-TO-NOISE RATIO ESTIMATE FOR A TRANSPORT BLOCK

(71) Applicant: QUALCOMM Incorporated, San Diego, CA (US)

(72) Inventors: Ahmed Elshafie, San Diego, CA (US); Wei Yang, San Diego, CA (US); Yi Huang, San Diego, CA (US)

(21) Appl. No.: 17/840,378

(22) Filed: Jun. 14, 2022

(51) Int. Cl. H04L 1/00; H04L 1/20; H04W 24/08

(52) U.S. Cl. CPC H04L 1/0063; H04L 1/0003; H04L 1/203; H04W 24/08

(57) ABSTRACT

Methods, systems, and devices for wireless communications are described. A user equipment (UE) may monitor for a downlink transmission from a network device, the downlink transmission comprising a set of parity bits. The UE may determine, based at least in part on the monitoring, a number of parity checks of the set of parity bits that either failed a parity check procedure or satisfied the parity check procedure. The UE may identify, based at least in part on the monitoring and the number of parity checks, a feedback status indicator for the downlink transmission. The UE may transmit a feedback message that includes the feedback status indicator and additional information based at least in part on the number of parity checks.

### TECHNICAL FIELD

The following relates to wireless communications, including methods to compute a signal-to-noise ratio estimate for a transport block.

### BACKGROUND

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network devices or one or more network access nodes, each simultaneously supporting communication for multiple communication devices, which may be otherwise known as user equipment (UE).

### SUMMARY

The described techniques relate to improved methods, systems, devices, and apparatuses that support methods to compute a signal-to-noise ratio (SNR) estimate for a transport block. Generally, the described techniques provide a solution where a user equipment (UE) sends parity check information (or information derived from parity check information) to a network device. The network device then determines a modulation and coding scheme (MCS) from the received information and then uses the determined MCS for communications with the UE. The network device is able to use the parity check information to determine an appropriate MCS, or just use an MCS suggested by the UE, in a retransmission.

A UE may monitor for a downlink transmission from a network device. The downlink transmission may include systematic bits and parity bits. The parity bits are used by the UE during the attempted decoding to confirm that the packets of the downlink transmission were successfully received and decoded. For example, the UE may run parity checks (e.g., parity check procedure iterations) on the received parity bits. Based on whether the parity bits fail or pass the parity check procedure, the UE may then recover the information from the downlink transmission. The UE may identify or otherwise determine a feedback status indicator for the downlink transmission that is transmitted to the network device in a feedback message. In addition, the UE may include in the feedback message additional information associated with the parity checks, e.g., how many parity checks were successful or unsuccessful, the ratio of successful or unsuccessful parity checks to the total number of parity checks. Alternatively, the UE may use tables provided to the UE to map a parity check value to an SNR. In some examples, the UE may indicate in the feedback message the SNR of the channel and/or a preferred MCS derived from the SNR (e.g., the UE uses the parity check information to determine the SNR and/or a more suitable MCS).

A method for wireless communication at a UE is described. The method may include monitoring for a downlink transmission from a network device, the downlink transmission including a set of parity bits, determining, based on the monitoring, a number of parity checks of the set of parity bits that either failed a parity check procedure or satisfied the parity check procedure, identifying, based on the monitoring and the number of parity checks, a feedback status indicator for the downlink transmission, and transmitting a feedback message that includes the feedback status indicator and additional information based on the number of parity checks.

An apparatus for wireless communication at a UE is described. The apparatus may include at least one processor, memory coupled (e.g., operatively, communicatively, functionally, electronically, or electrically) with the at least one processor, and instructions stored in the memory. The instructions may be executable by the at least one processor to cause the apparatus to monitor for a downlink transmission from a network device, the downlink transmission including a set of parity bits, determine, based on the monitoring, a number of parity checks of the set of parity bits that either failed a parity check procedure or satisfied the parity check procedure, identify, based on the monitoring and the number of parity checks, a feedback status indicator for the downlink transmission, and transmit a feedback message that includes the feedback status indicator and additional information based on the number of parity checks.

Another apparatus for wireless communication at a UE is described. The apparatus may include means for monitoring for a downlink transmission from a network device, the downlink transmission including a set of parity bits, means for determining, based on the monitoring, a number of parity checks of the set of parity bits that either failed a parity check procedure or satisfied the parity check procedure, means for identifying, based on the monitoring and the number of parity checks, a feedback status indicator for the downlink transmission, and means for transmitting a feedback message that includes the feedback status indicator and additional information based on the number of parity checks.

A non-transitory computer-readable medium storing code for wireless communication at a UE is described. The code may include instructions executable by at least one processor to monitor for a downlink transmission from a network device, the downlink transmission including a set of parity bits, determine, based on the monitoring, a number of parity checks of the set of parity bits that either failed a parity check procedure or satisfied the parity check procedure, identify, based on the monitoring and the number of parity checks, a feedback status indicator for the downlink transmission, and transmit a feedback message that includes the feedback status indicator and additional information based on the number of parity checks.

Some examples of the method, apparatuses, and non-transitory computer-readable medium described herein may further include operations, features, means, or instructions for mapping the number of parity checks to a SNR associated with a channel used for the downlink transmission and identifying a MCS based on the SNR, where the additional information in the feedback message may be the MCS.

In some examples of the method, apparatuses, and non-transitory computer-readable medium described herein, mapping the number of parity checks may include operations, features, means, or instructions for correlating the number of parity checks to a SNR reference based on one or more iterations of the parity check procedure.

In some examples of the method, apparatuses, and non-transitory computer-readable medium described herein, identifying the MCS may include operations, features, means, or instructions for identifying a highest available MCS supported by the SNR.

In some examples of the method, apparatuses, and non-transitory computer-readable medium described herein, identifying the MCS may include operations, features, means, or instructions for identifying an estimated block error rate for the downlink transmission based on the number of parity checks.

Some examples of the method, apparatuses, and non-transitory computer-readable medium described herein may further include operations, features, means, or instructions for including the number of parity checks as the additional information in the feedback message.

Some examples of the method, apparatuses, and non-transitory computer-readable medium described herein may further include operations, features, means, or instructions for performing one or more iterations of the parity check procedure on the set of parity bits of the downlink transmission.

Some examples of the method, apparatuses, and non-transitory computer-readable medium described herein may further include operations, features, means, or instructions for identifying the number of parity checks after each iteration of the parity check procedure.

Some examples of the method, apparatuses, and non-transitory computer-readable medium described herein may further include operations, features, means, or instructions for identifying the number of parity checks after a final iteration of the parity check procedure.

Some examples of the method, apparatuses, and non-transitory computer-readable medium described herein may further include operations, features, means, or instructions for identifying the number of parity checks at an intermediate iteration of the parity check procedure.

Some examples of the method, apparatuses, and non-transitory computer-readable medium described herein may further include operations, features, means, or instructions for identifying the number of parity checks based on the parity checks that satisfied the parity check procedure.

Some examples of the method, apparatuses, and non-transitory computer-readable medium described herein may further include operations, features, means, or instructions for identifying the number of parity checks based on the parity checks that failed the parity check procedure.

Some examples of the method, apparatuses, and non-transitory computer-readable medium described herein may further include operations, features, means, or instructions for identifying the number of parity checks based on a ratio of parity checks that satisfied the parity check procedure to parity checks that failed the parity check procedure.

Some examples of the method, apparatuses, and non-transitory computer-readable medium described herein may further include operations, features, means, or instructions for identifying the number of parity checks based on a ratio of parity checks that satisfied the parity check procedure to a total number of parity checks for the downlink transmission.

Some examples of the method, apparatuses, and non-transitory computer-readable medium described herein may further include operations, features, means, or instructions for identifying the number of parity checks based on a ratio of parity checks that failed the parity check procedure to a total number of parity checks for the downlink transmission.

Some examples of the method, apparatuses, and non-transitory computer-readable medium described herein may further include operations, features, means, or instructions for identifying, based on signaling exchanged with the network device, a set of indicator values associated with the number of parity checks.

In some examples of the method, apparatuses, and non-transitory computer-readable medium described herein, the set of indicator values include indicator values corresponding to a quantization of the number of parity checks.

Some examples of the method, apparatuses, and non-transitory computer-readable medium described herein may further include operations, features, means, or instructions for receiving an indication of the set of indicator values from the network device using at least one of radio resource control (RRC) signaling, a medium access control (MAC) control element (CE) message, a downlink control information (DCI) message, a UE-assistance information message, or a combination thereof.

Some examples of the method, apparatuses, and non-transitory computer-readable medium described herein may further include operations, features, means, or instructions for identifying the number of parity checks based at least in part on a number of layers, a transport-block size (TBS), a target block level error rate (BLER), or any combination thereof, associated with the downlink transmission.

In some examples of the method, apparatuses, and non-transitory computer-readable medium described herein, the downlink transmission comprises a cellular-based downlink transmission received from a network device or a sidelink-based downlink transmission received from a neighboring UE.

A method for wireless communication at a network device is described. The method may include transmitting, to a UE, a downlink transmission that includes a set of parity bits, receiving a feedback message from the UE that includes a feedback status indicator and additional information based on a number of parity checks associated with the set of parity bits, the number of parity checks being based on parity checks of the set of parity bits that either failed a parity check procedure or satisfied the parity check procedure, and selecting a MCS for communications with the UE based on the feedback message.

An apparatus for wireless communication at a network device is described. The apparatus may include at least one processor, memory coupled (e.g., operatively, communicatively, functionally, electronically, or electrically) with the at least one processor, and instructions stored in the memory. The instructions may be executable by the at least one processor to cause the apparatus to transmit, to a UE, a downlink transmission that includes a set of parity bits, receive a feedback message from the UE that includes a feedback status indicator and additional information based on a number of parity checks associated with the set of parity bits, the number of parity checks being based on parity checks of the set of parity bits that either failed a parity check procedure or satisfied the parity check procedure, and select a MCS for communications with the UE based on the feedback message.

Another apparatus for wireless communication at a network device is described. The apparatus may include means for transmitting, to a UE, a downlink transmission that includes a set of parity bits, means for receiving a feedback message from the UE that includes a feedback status indicator and additional information based on a number of parity checks associated with the set of parity bits, the number of parity checks being based on parity checks of the set of parity bits that either failed a parity check procedure or satisfied the parity check procedure, and means for selecting a MCS for communications with the UE based on the feedback message.

A non-transitory computer-readable medium storing code for wireless communication at a network device is described. The code may include instructions executable by at least one processor to transmit, to a UE, a downlink transmission that includes a set of parity bits, receive a feedback message from the UE that includes a feedback status indicator and additional information based on a number of parity checks associated with the set of parity bits, the number of parity checks being based on parity checks of the set of parity bits that either failed a parity check procedure or satisfied the parity check procedure, and select a MCS for communications with the UE based on the feedback message.

Some examples of the method, apparatuses, and non-transitory computer-readable medium described herein may further include operations, features, means, or instructions for identifying the MCS based on a SNR associated with a channel used for the downlink transmission, where the additional information in the feedback message may be the MCS.

Some examples of the method, apparatuses, and non-transitory computer-readable medium described herein may further include operations, features, means, or instructions for identifying the number of parity checks based on the additional information in the feedback message and identifying the MCS based on the number of parity checks.

In some examples of the method, apparatuses, and non-transitory computer-readable medium described herein, the number of parity checks may be identified based on the parity checks that satisfied the parity check procedure.

In some examples of the method, apparatuses, and non-transitory computer-readable medium described herein, the number of parity checks may be identified based on the parity checks that failed the parity check procedure.

In some examples of the method, apparatuses, and non-transitory computer-readable medium described herein, the number of parity checks may be identified based on a ratio of parity checks that satisfied the parity check procedure to parity checks that failed the parity check procedure.

In some examples of the method, apparatuses, and non-transitory computer-readable medium described herein, the number of parity checks may be identified based on a ratio of parity checks that satisfied the parity check procedure to a total number of parity checks for the downlink transmission.

In some examples of the method, apparatuses, and non-transitory computer-readable medium described herein, the number of parity checks may be identified based on a ratio of parity checks that failed the parity check procedure to a total number of parity checks for the downlink transmission.

Some examples of the method, apparatuses, and non-transitory computer-readable medium described herein may further include operations, features, means, or instructions for identifying, based on signaling exchanged with the UE, a set of indicator values associated with the number of parity checks.

In some examples of the method, apparatuses, and non-transitory computer-readable medium described herein, the set of indicator values include indicator values corresponding to a quantization of the number of parity checks.

Some examples of the method, apparatuses, and non-transitory computer-readable medium described herein may further include operations, features, means, or instructions for transmitting an indication of the set of indicator values to the UE using at least one of RRC signaling, a MAC CE message, a DCI message, a UE-assistance information message, or a combination thereof.

### BRIEF DESCRIPTION OF THE DRAWINGS

FIG. 1 illustrates an example of a wireless communication system that supports methods to compute a signal-to-noise ratio (SNR) estimate for a transport block in accordance with aspects of the present disclosure.

FIG. 2 illustrates an example of a wireless communication system that supports methods to compute an SNR estimate for a transport block in accordance with aspects of the present disclosure.

FIG. 3 illustrates an example of a decoding configuration that supports methods to compute an SNR estimate for a transport block in accordance with aspects of the present disclosure.

FIG. 4 illustrates an example of a process that supports methods to compute an SNR estimate for a transport block in accordance with aspects of the present disclosure.

FIGS. 5 and 6 show block diagrams of devices that support methods to compute an SNR estimate for a transport block in accordance with aspects of the present disclosure.

FIG. 7 shows a block diagram of a communications manager that supports methods to compute an SNR estimate for a transport block in accordance with aspects of the present disclosure.

FIG. 8 shows a diagram of a system including a device that supports methods to compute an SNR estimate for a transport block in accordance with aspects of the present disclosure.

FIGS. 9 and 10 show block diagrams of devices that support methods to compute an SNR estimate for a transport block in accordance with aspects of the present disclosure.

FIG. 11 shows a block diagram of a communications manager that supports methods to compute an SNR estimate for a transport block in accordance with aspects of the present disclosure.

FIG. 12 shows a diagram of a system including a device that supports methods to compute an SNR estimate for a transport block in accordance with aspects of the present disclosure.

FIGS. 13 through 17 show flowcharts illustrating methods that support methods to compute an SNR estimate for a transport block in accordance with aspects of the present disclosure.

### DETAILED DESCRIPTION

Some wireless communication systems may use turbo hybrid automatic repeat request (HARQ) procedures to improve latency and reliability. For example, a user equipment (UE) may be configured to not only indicate a negative acknowledgment (NACK), but to also indicate with the NACK additional channel state information (CSI). The network device uses this combination of information to select a more appropriate modulation and coding scheme (MCS) for communicating with the UE to avoid or minimize additional failed transmissions. For example, the CSI information in combination with the NACK indicating that the UE was unable to successfully receive and decode the downlink transmission may provide an indication of the channel conditions of the channel being used for communications with the UE. Accordingly, the network device may select an MCS for communicating with the UE that is more suitable to the channel conditions. However, the CSI included with the NACK may be out of date. Additionally, traditional methods for providing other indicators of an appropriate MCS are challenging in circumstances where the UE is to transmit a NACK— as the UE often lacks information pertaining to the signal that gave rise to the NACK.

Aspects of the disclosure are initially described in the context of wireless communication systems. Generally, the described techniques provide a solution where a UE sends parity check information to a network device that derives an MCS from parity check information and then uses the derived MCS in communications with the UE. The network device is able to use the parity check information to determine an appropriate MCS, or just use an MCS suggested by the UE, in a retransmission. A UE may monitor for a downlink transmission from a network device. The downlink transmission may include systematic bits and parity bits. The parity bits are used by the UE during the attempted decoding to confirm that the packets of the downlink transmission were successfully received and decoded. For example, the UE may run parity checks (e.g., parity check procedure iterations) on the received parity bits. Based on whether the parity bits fail or pass the parity check procedure, the UE may then recover the information from the downlink transmission. The UE may identify or otherwise determine a feedback status indicator for the downlink transmission, that is transmitted to the network device in a feedback message. In addition, the UE may include in the feedback message additional information associated with the parity checks, e.g., how many parity checks were successful or unsuccessful, the ratio of successful or unsuccessful parity checks to the total number of parity checks. Alternatively, the UE may use tables provided to the UE to map a parity check value to an SNR. In some examples, the UE may indicate in the feedback message the SNR of the channel and/or a preferred MCS derived from the SNR (e.g., the UE uses the parity check information to determine the SNR and/or a more suitable MCS).

Aspects of the disclosure are further illustrated by and described with reference to apparatus diagrams, system diagrams, and flowcharts that relate to methods to compute an SNR estimate for a transport block.

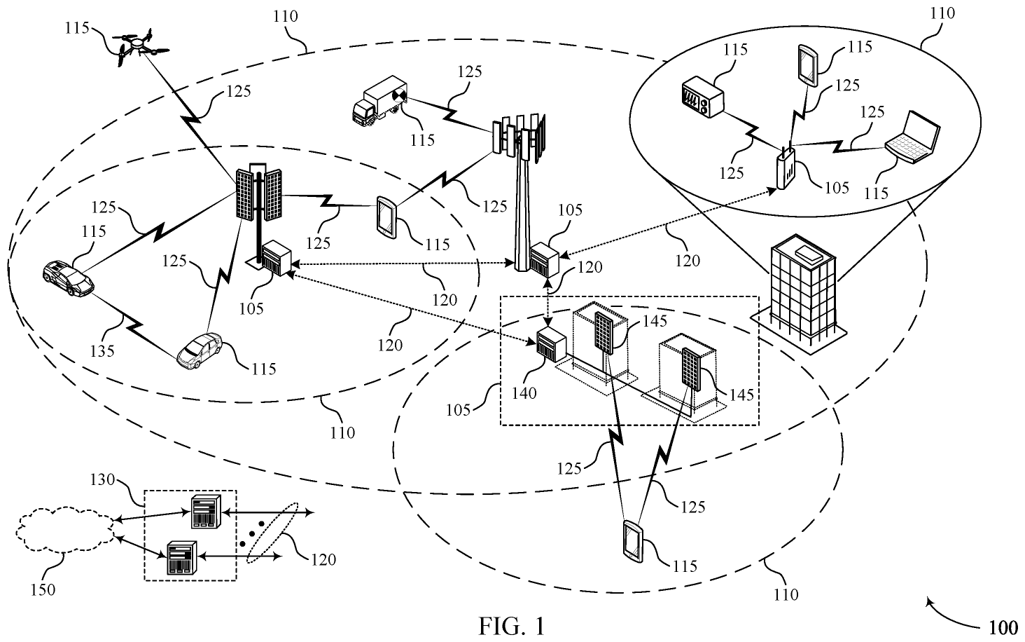

FIG. 1 illustrates an example of a wireless communication system 100 that supports methods to compute an SNR estimate for a transport block in accordance with aspects of the present disclosure. The wireless communication system 100 may include one or more network devices 105, one or more UEs 115, and a core network 130. In some examples, the wireless communication system 100 may be a Long Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof.

The network devices 105 may be dispersed throughout a geographic area to form the wireless communication system 100 and may be devices in different forms or having different capabilities. The network devices 105 and the UEs 115 may wirelessly communicate via one or more communication links 125. Each network device 105 may provide a coverage area 110 over which the UEs 115 and the network device 105 may establish one or more communication links 125. The coverage area 110 may be an example of a geographic area over which a network device 105 and a UE 115 may support the communication of signals according to one or more radio access technologies.

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network devices 105, or network equipment (e.g., core network nodes, relay devices, integrated access and backhaul (IAB) nodes, or other network equipment), as shown in FIG. 1.

The network devices 105 may communicate with the core network 130, or with one another, or both. For example, the network devices 105 may interface with the core network 130 through one or more backhaul links 120 (e.g., via an S1, N2, N3, or other interface). The network devices 105 may communicate with one another over the backhaul links 120 (e.g., via an X2, Xn, or other interface) either directly (e.g., directly between network devices 105), or indirectly (e.g., via core network 130), or both. In some examples, the backhaul links 120 may be or include one or more wireless links.

One or more of the network devices 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network devices 105 and the network equipment including macro eNBs or gNBs, small cell eNBs or gNBs, or relay network devices, among other examples, as shown in FIG. 1.

The UEs 115 and the network devices 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communication system 100 may include uplink transmissions from a UE 115 to a network device 105, or downlink transmissions from a network device 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or megahertz (MHz)). Devices of the wireless communication system 100 (e.g., the network devices 105, the UEs 115, or both) may have hardware configurations that support communications over a particular carrier bandwidth or may be configurable to support communications over one of a set of carrier bandwidths. In some examples, the wireless communication system 100 may include network devices 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network devices 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each network device 105 may provide communication coverage via one or more cells, for example a macro cell, a small cell, a hot spot, or other types of cells, or any combination thereof. The term “cell” may refer to a logical communication entity used for communication with a network device 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the network device 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network device 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network device 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network device 105 may be movable and therefore provide communication coverage for a moving geographic coverage area 110. In some examples, different geographic coverage areas 110 associated with different technologies may overlap, but the different geographic coverage areas 110 may be supported by the same network device 105. In other examples, the overlapping geographic coverage areas 110 associated with different technologies may be supported by different network devices 105. The wireless communication system 100 may include, for example, a heterogeneous network in which different types of the network devices 105 provide coverage for various geographic coverage areas 110 using the same or different radio access technologies.

The wireless communication system 100 may support synchronous or asynchronous operation. For synchronous operation, the network devices 105 may have similar frame timings, and transmissions from different network devices 105 may be approximately aligned in time. For asynchronous operation, the network devices 105 may have different frame timings, and transmissions from different network devices 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network device 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network device 105. Other UEs 115 in such a group may be outside the geographic coverage area 110 of a network device 105 or be otherwise unable to receive transmissions from a network device 105. In some examples, groups of the UEs 115 communicating via D2D communications may utilize a one-to-many (1:M) system in which each UE 115 transmits to every other UE 115 in the group. In some examples, a network device 105 facilitates the scheduling of resources for D2D communications. In other cases, D2D communications are carried out between the UEs 115 without the involvement of a network device 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network devices 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network devices 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices 105, such as a base station, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network device 105 may be distributed across various network devices 105 (e.g., radio heads and ANCs) or consolidated into a single network device 105.

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the network devices 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network devices 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network device 105 or a UE 115 may be equipped with multiple antennas, which may be used to employ techniques such as transmit diversity, receive diversity, multiple-input multiple-output (MIMO) communications, or beamforming. The antennas of a network device 105 or a UE 115 may be located within one or more antenna arrays or antenna panels, which may support MIMO operations or transmit or receive beamforming. For example, one or more network device antennas or antenna arrays may be co-located at an antenna assembly, such as an antenna tower. In some examples, antennas or antenna arrays associated with a network device 105 may be located in diverse geographic locations. A network device 105 may have an antenna array with a number of rows and columns of antenna ports that the network device 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The network devices 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network device 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network device 105 or a UE 115 may use beam sweeping techniques as part of beam forming operations. For example, a network device 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network device 105 multiple times in different directions. For example, the network device 105 may transmit a signal according to different beamforming weight sets associated with different directions of transmission. Transmissions in different beam directions may be used to identify (e.g., by a transmitting device, such as a network device 105, or by a receiving device, such as a UE 115) a beam direction for later transmission or reception by the network device 105.

Some signals, such as data signals associated with a particular receiving device, may be transmitted by a network device 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network device 105 in different directions and may report to the network device 105 an indication of the signal that the UE 115 received with a highest signal quality or an otherwise acceptable signal quality.

In some examples, transmissions by a device (e.g., by a network device 105 or a UE 115) may be performed using multiple beam directions, and the device may use a combination of digital precoding or radio frequency beamforming to generate a combined beam for transmission (e.g., from a network device 105 to a UE 115). The UE 115 may report feedback that indicates precoding weights for one or more beam directions, and the feedback may correspond to a configured number of beams across a system bandwidth or one or more sub-bands. The network device 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network device 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the network device 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest SNR, or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a network device 105 or a core network 130 supporting radio bearers for user plane data. At the physical layer, transport channels may be mapped to physical channels.

The UEs 115 and the network devices 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may monitor for a downlink transmission from a network device 105, the downlink transmission comprising a set of parity bits. The UE 115 may determine, based at least in part on the monitoring, a number of parity checks of the set of parity bits that either failed a parity check procedure or satisfied the parity check procedure. The UE 115 may identify, based at least in part on the monitoring and the number of parity checks, a feedback status indicator for the downlink transmission. The UE 115 may transmit a feedback message that includes the feedback status indicator and additional information based at least in part on the number of parity checks.

A network device 105 may transmit, to a UE 115, a downlink transmission that comprises a set of parity bits. The network device 105 may receive a feedback message from the UE 115 that includes a feedback status indicator and additional information based at least in part on a number of parity checks associated with the set of parity bits, the number of parity checks being based at least in part on parity checks of the set of parity bits that either failed a parity check procedure or satisfied the parity check procedure. The network device 105 may select an MCS for communications with the UE 115 based at least in part on the feedback message.

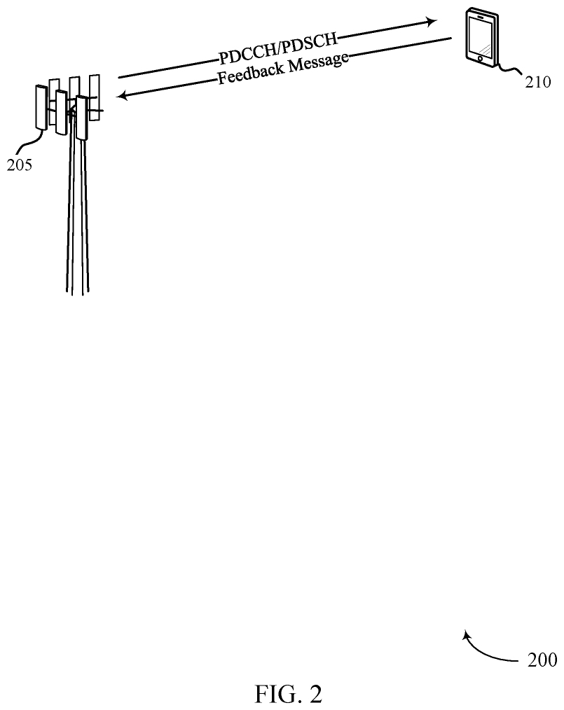

FIG. 2 illustrates an example of a wireless communication system 200 that supports methods to compute an SNR estimate for a transport block in accordance with aspects of the present disclosure. Wireless communication system 200 may implement aspects of wireless communication system 100. Wireless communication system 200 may include network device 205 and/or UE 210, which may be examples of the corresponding devices described herein.

Wireless communication system 200 may support turbo-HARQ. Broadly, this may include UE 210 supporting HARQ-ACK and CSI feedback, which provides faster CQI feedback to achieve ultra-reliability for a first retransmission. For example, improved latency may be achieved by reducing the number of retransmissions to only one retransmission. For example, initially network device 205 may map an incoming packet available for transmission to an MCS based on a target block error rate (BLER) determined based on the current understanding of the channel quality. UE 210 may attempt to decode the initial transmission, but may fail. UE 210 may attempt to determine the channel capacity based on the signal-to-interference-to-noise ratio (SINR). When transmitting a NACK indication for the downlink transmission that failed decoding, UE 210 may include an indication of CSI in the feedback message to network device 205. Network device 205 may receive the NACK indication and CSI indication in the feedback message and map a retransmission of the downlink information to an MCS determined based on an updated understanding of the CQI (e.g., based on the CSI indication received from UE 210). For example, the coding length and resources used for the retransmission may be determined based on the received CSI feedback from UE 210. Accordingly, network device 205 may retransmit the downlink information to UE 210 using the newly mapped MCS, which is more suitable to the current channel conditions. This may result in successful decoding of the downlink transmission by UE 210.

Accordingly, turbo-HARQ may achieve a residual BLER with a maximum of two HARQ transmissions. The MCS of the first transmission may be based on periodic CQI reports received from UE 210 and the MCS of the retransmission may be based on the asynchronous CSI report sent with the ACK/NACK feedback (e.g., super-ACK).

Accordingly, wireless communication system 200 may support various CSI enhancements. Such CSI enhancements may include new CSI reporting based on other measurements providing additional information (e.g., based on PDCCH/PDSCH decoding). This may support CSI feedback being provided for PDCCH. This may include downlink triggered CSI-RS reporting being supported for reduced latency and increased reliability. For example, in the downlink DCI, a CSI trigger field (e.g., Z bits) may be used to indicate the CSI trigger (which may include the CSI report setting and CSI-RS resource setting). In some configurations, UE 210 may transmit CSI plus the ACK information in the same PUCCH resource. In another configuration, UE 210 may transmit CSI and ACK in separate PUCCH resources.

Accordingly, turbo-HARQ may be beneficial in many scenarios. An example scenario may include deep fading cases (e.g., when the channel goes into deep fade, turbo HARQ helps network device 205 better understand the channel quickly and adapt accordingly). Another example scenario may include interference cases where the interference is bursty. Another example scenario may include improved resource block/resource allocations when the Inner-loop CQIs are driven by: SRS-based MCS (e.g., especially when the network device 205 receiver experiences different noise/interference than characteristics than the UE 210 side, which is the practical case) and/or SRS/CSI-RS with high periodicity (e.g., having a quick feedback based on PDSCH can help both outer-loop for the next transmission or quick mitigation of interference during bursty interference during a retransmission).

Wireless communication system 200 may support estimating SNR based on PDSCH. However, estimating SNR of the channel using the DMRS portion of PDSCH may not be an option. Log-likelihood ratio (LLR) techniques for such SNR estimation may use LLR based metrics may only be useful when there is an ACK for the downlink transmission (e.g., when the UE is able to be successfully receive and decode the downlink transmission) because, once there is a BLER or NACK, the LLR metric becomes useless and i/p and o/p LLRs are not representative.

Accordingly, aspects of the described techniques provide a method to determine the SNR from a NACK′d transport block (TB) (e.g., the downlink transmission). In some aspects, this may include using the low density parity checks (LDPCs) number of checked parities, which has a direct link to the actual SNR of the signal, to determine an estimate of the SNR. Then, either using an average number of unchecked parity check bits versus SNR curves for different MCS levels or using the link-curves for a given target BLER, the SNR can be mapped to an MCS. This may enable UE 210 to determine an optimal MCS to be used in a retransmission by network device 205 to zero-out the channel error.

That is, since the output LLRs of the decoder of UE 210 are in error and are not useful when there is a BLER, the previous methods cannot be used since they rely on the assumption that the output LLRs are error-free (e.g., with a high probability). Attempting to estimate the SNR using zero-crossing per-LLR and mapping this metric to an estimated SNR is inaccurate (e.g., shows a bell-like relation with SNR). Accordingly, aspects of the described techniques may count the number of checked parity bits per downlink transmission. UE 210 may map the number of checked parity bits to an SNR curve to determine a more accurate SNR of the channel to be provided in the feedback message. Since the number of checked parity bits has a direct connection to the actual bit-error-rate of the downlink transmission, the more parity bits that have been checked, the more confidence that the data is correctly decoded. When all parity bits have been checked (e.g., pass the parity check), this means there is no error for the downlink transmission and the MCS-to-channel mapping is correct for the channel. However, as the number of parity bits that are unchecked (e.g., fail the parity check), then this may be more indicative of the actual channel quality (e.g., SNR), which may be used to more appropriately map the highest MCS to the channel conditions for a retransmission.

Accordingly, network device 205 may transmit a downlink transmission (e.g., PDCCH and/or PDSCH) to UE 210. The downlink transmission may include a set of parity bits. UE 210 and network device 205 may each know the number of parity bits in the set of parity bits per rate-matched transport block. For example, some control/information bits may be backed up by multiple parity bits (e.g., out of F bits in the transport block, G bits may carry data/control information and H bits may carry parity information). UE 210 may identify or otherwise determine the number of parity checks of the set of parity bits that fail or satisfy the parity check procedure. For example, UE 210 may attempt to decode the downlink transmission (e.g., the TB carrying the information, which includes the parity bits) using the set of parity bits. UE 210 may iteratively attempt to decode the downlink transmission using an encoder/decoder function/component that uses the parity bits to confirm that the information/control bits are successfully recovered from the downlink transmission.

Broadly, the number of parity checks that fails or satisfy the parity check procedure may be based on various metrics. For example, a first metric may include UE 210 identifying or otherwise determining the number of parity checks according to the number of parity checks that satisfy the parity check procedure (e.g., #satisfied/checked parity checks). Another example metric may include UE 210 identifying or otherwise determining the number of parity checks that fail the parity check procedure (e.g., #unsatisfied/unchecked parity checks). Another example metric may include UE 210 identifying or otherwise determining a ratio of parity checks that satisfy the parity procedure to the parity checks that failed the parity check procedure (e.g., percentage/ratio of unsatisfied/unchecked parity checks over all parity checks of the downlink transmission). Another example metric may include UE 210 identifying or otherwise determining a ratio of parity checks that satisfy the parity procedure to the total number of parity checks for the downlink transmission (e.g., percentage/ratio of satisfied/checked parity checks over all parity checks of the downlink transmission).

In some examples UE 210 may iteratively attempt to decode the downlink transmission. For example, UE 210 may perform iteration(s) of the parity check procedure using the parity bits of the downlink transmission. UE 210 may identify or otherwise determine the number parity checks after a particular iteration of the attempted decoding procedure. For example, UE 210 may identify the number of parity checks after each iteration of the parity check procedure, after a final iteration of the parity check procedure, and/or after some intermediate iteration of the parity check procedure. Accordingly, the metric regarding the number of parity checks that fail or satisfy the parity check procedure may be computed at each iteration of the decoder, after a final iteration of the decoder, and/or at a particular iteration of the decoder (e.g., after the first iteration, the 15th iteration, or other iterations).

UE 210 may also identify or otherwise determine a feedback status indicator (e.g., ACK/NACK) for the downlink transmission (e.g., based on the result of the attempted decoding). For example, UE 210 may, e.g., based on the parity checks and/or other decoding functions/steps, determine whether it was able to successfully receive and decode the downlink transmission (e.g., PDCCH and/or PDSCH). In the situation where UE 210 is able to successfully receive and decode the downlink transmission, the feedback status indicator may include an ACK indicator. In the situation where UE 210 is unable to successfully receive and decode the downlink transmission, the feedback status indicator may include a NACK indicator.

In some aspects, at which iteration of the parity check procedures to stop and report for ACK and/or NACK codeblocks and/or CBGs may vary. For example, network device 205 may configure UE 210 with certain metric reporting options for a given set of iterations that are based on whether an ACK or NACK feedback status indicator is reported. Network device 205 may configure UE 210 to transmit metrics (e.g., number and/or ratio of successful and/or unsuccessful parity checks, such as over the total number of parity checks performed for the downlink transmission) at iteration 1, 5, and 8, for example, for ACK cases or at iteration 16 and 18, for example, for NACK cases. Network device 205 may request UE 210 to send the additional information (e.g., CSI) for X iterations, which may use an X1 value for the ACK cases and an X2 value for the NACK cases). Such request may be signaled from network device 205 to UE 210 using various configuration signaling, such as RRC signaling, MAC CE signaling, or DCI, Moreover, network device 205 may request UE 210 to report in the additional information (e.g., the metrics) for multiple iterations, such as iterations 1, 4, 18, or another other number(s) of iterations.

Based on the feedback status indicator (e.g., a NACK indicator), UE 210 may also identify or otherwise determine additional information to include in the feedback message (e.g., in addition to the NACK indication) that is based on the number of parity checks (e.g., the number of parity checks that pass/fail the parity check procedure). Broadly, the additional information may provide, directly and/or indirectly, information associated with the channel conditions. For example, UE 210 may identify or otherwise determine an estimated/empirical BER or a hypothetical BLER, based on the number parity checks (e.g., from the ratio of unsatisfied checks, UE 210 may estimate the range of the empirical BER). Network device 205 may use the additional information to update its understanding of the current channel conditions, and therefore map a more appropriate MCS to retransmissions to UE 210 (and/or other communications with UE 210) to reduce latency and improve reliability. Accordingly, the additional information based on the number of parity checks may include the number of parity checks, an SNR based on the parity checks, a preferred/requested MCS that is based on the number of parity checks/SNR.

In one example, UE 210 may include the number of parity checks (e.g., the number of failed/passed parity checks or ratio of passed/failed parity checks) as the additional information in the feedback message. That is, for more flexibility UE 210 can signal the number of unchecked LDPC bits and network device 205 may use this information as appropriate.

In another example, UE 210 may signal the MCS as the additional information, which may be identified, determined, or otherwise obtained from mapping the average number of unchecked LDPC parities to an SNR and then using linked curves to map the SNR to an MCS for a target BLER. For example, UE 210 may map the number of parity checks to an SNR associated with the channel used for the downlink transmission. UE 210 may identify or otherwise determine an MCS based on the SNR. In this example, UE 210 may include the MCS as the additional information in the feedback message. In some examples, mapping the number of parity checks to an SNR may include UE 210 correlating the number of parity checks to an SNR reference based on iteration(s) of the parity check procedure. UE 210 may identify or otherwise determine a highest MCS supported by the SNR and signal this optimal MCS as the additional information. In some examples, this may include UE 210 identifying or otherwise determining an estimated BLER for the downlink transmission based on the number of parity checks. Based on the estimation BLER, UE 210 may identify or otherwise determine the highest MCS for the channel that achieves or otherwise supports a number of parity checks that satisfies a threshold (e.g., reduces the number of parity checks that fail the parity check procedure to a very low or zero number).

In some aspects, the TB (e.g., the downlink transmission) may generally include a plurality of codeblock groups (CBGs), with each CBG including multiple codeblocks. UE 210 may attempt to decode the downlink transmission using a decoder. The decoder may attempt to decode each codeblock of the downlink transmission. The number of parity checks that pass or fail the decoding attempt may be on a per-codeblock basis (e.g., the number of parity checks is based on an attempt to decode each codeblocks in the CBG(s) of the downlink transmission). That is, each codeblock of the downlink transmission may be associated with its own number/ratio of parity checks that pass or fail the parity check procedures. The number/ratio of parity checks that pass or fail the parity check procedure may be based on the number of parity bits in the codeblock. If a CBG (which includes multiple codeblocks) is unable to be successfully received and decoded, the feedback status indicator may indicate NACK and the CBG may be retransmitted by network device 205. Accordingly, in some aspects the feedback status indicator may be on a per-CBG basis. Accordingly, the additional information provided in the feedback message may include CSI information that is based on an all codeblocks in each CBG basis (e.g., on a per codeblock and/or CBG basis) and/or may be based on all codeblocks across all CBGs (e.g., on a per transport block basis where the sum of all metrics across all codeblocks is computed over all parity checks across all codeblocks). As discussed, the number of parity checks may generally indicate the number and/or ratio of successful and/or failed parity checks.

In some aspects, the TB (e.g., the downlink transmission) may generally include a plurality of layers (e.g., spatial layers, antenna ports, beamforming group, etc.). UE 210 may attempt to decode the downlink transmission using a decoder. The UE may compute the number/ratio of parity checks that pass or fail the parity check procedure, which may depend on all received signal(s) across all layers. Then (e.g., based on the number of downlink transmissions within a given #layers or TBS or target BLER or combination thereof), UE 210 may compare the parity check ratio with stored tables/curves of ratio vs SINR for each MCS, these tables may be functions of one of #layers and TBS and target BLER used for the scheduled transmission, and are used to obtain the current SINR for the scheduled MCS. After obtaining the SINR, UE 210 may use a mapping function/table to convert the SINR to an MCS for a given desired one or more of target BLER.

Accordingly, UE 210 may measure the ratio between unsatisfactory parity checks and total parity checks. Based on the scheduled downlink transmission (e.g., CBG, TBS, layers, where the TBS may be determined based on current MCS, layer number, etc.), a link curve may show the ratio between unsatisfactory parity checks and total parity checks for each MCS value (with multiple curves being a function of TBS and the number of layers). Then, based on a scheduled MCS and the measured ratio between unsatisfactory parity checks and total parity checks and the scheduled transmission target BLER, UE 210 may determine the current SINR. For example, taking the measured SINR and using the line curve showing the BLER vs SINR for each MCS, UE 210 may select the MCS for the required target BLER. As one non-limiting example, a SINR of 20 dB may correspond to using a BLER of 1e-3, which thus results in a specific requested MCS. UE 210 may report the MCS of one or more of target BLER to gNB.

Accordingly, in some examples the additional information carried or otherwise conveyed in the feedback message may be on a per codeblock basis. In some examples, UE 210 may report the additional information on the per codeblock basis for each codeblock in the downlink transmission. In some examples, UE 210 may report the additional information on a worst codeblock basis. For example, UE 210 may compute the number of failed parity check, ratio of successful/failed parity checks, or ratio of failed successful parity checks over the total number of parity checks on a per codeblock basis, but then report the worst case metrics as the additional information (e.g., the x worst codeblocks, where x is a positive number). As all codeblocks in the downlink transmission will use the same MCS, if any codeblock fails in a retransmission (e.g., the retransmitted codeblocks fail the parity checks), then the channel may be unsuitable for communications.

In some examples, UE 210 may report the additional information in the feedback message on the per CBG basis. For example, the decoder of UE 210 will perform parity checks on each codeblock and may then sum the number/ratio of successful/failed parity checks for the codeblocks across all codeblocks per CBG for all codeblocks in the downlink transmission. This summation may be indicated as the additional information carried or otherwise conveyed in the feedback message.

In some examples, there may be two approaches for CBGs reporting based on whether the feedback status indicator is ACK or NACK. For ACK CBGs, UE 210 may report in the additional information the worst case scenario, such as the metric (e.g., the number of unsatisfied parity checks, or the ratio of unsatisfied/satisfied parity checks over the total number of parity checks) as computed based on the worst codeblock (e.g., among all of the codeblocks in the CBGs). For ACK CBGs, UE 210 may transmit in the additional information an average of all metrics (e.g., a ratio of unsatisfactory to satisfactory parity checks over the total number of parity checks), an averaging of the metrics using the sum of the unsatisfied parity checks over the sum of the total number of parity checks performed, and/or an average of each metric individually. In some examples, UE 210 may transmit in the additional information the worst case scenario (e.g., as discussed above for NACK CBGs using all codeblocks in all ACK CBGs). In some examples, this may be reported in a single CSI report (e.g., the additional information carried in the feedback message. In some examples, UE 210 may report in the additional information the worst metric for each CBG (e.g., using the codeblocks of that CBG only). In some aspects, the report size for the additional information may be based on which information (e.g., which metric) is reported by UE 210 in the feedback message.

As one non-limiting example, this may include UE 210 attempting to decode a first codeblock (or CBG), which results in x unsuccessful parity checks and then attempting to decode a second codeblock (or CBG), which results in y unsuccessful parity checks (where x is a greater number than y). In this situation, UE 210 may include x as the additional information in the feedback message. As another non-limiting example, this may include UE 210 attempting to decode a first codeblock (or CBG), which results in a ratio of x unsuccessful parity checks-to-successful parity checks and then attempting to decode a second codeblock (or CBG), which results in a ratio of y unsuccessful parity checks-to-successful parity checks (where x is a greater number than y). In this situation, UE 210 may again include x as the additional information in the feedback message.

Accordingly, UE 210 may identify or otherwise include additional information in the feedback message that is based, at least in some aspects, on the number of parity checks that pass/fail the parity check procedure. Broadly, network device 205 and UE 210 may exchange various signaling (e.g., RRC signaling, MAC CE signaling, DCI signaling, or UE assistance information signaling) to agree on the quantization of the number of parity checks to include as the additional information in the feedback message. For example, a set of indicator values may be identified or otherwise agreed to that carry or otherwise conveys the additional information. This may include network device 205 and UE 210 negotiating or otherwise signaling table(s) that associate the number of transmitted LDPC bits and certain quantization levels and/or mechanisms that network device 205 and UE 210 will use to quantize the number of unchecked LDPC bit parities. The indicator values may correspond to, or otherwise provide information associated with, a quantization of the number of parity checks that fail/pass the parity check procedure for the downlink transmission.

As one non-limiting example, the set of indicator values may include two bits being included in the feedback message that carries the additional information associated with the number of parity checks. In this example, the two bits being set to “00” may indicate 1-10 as the number of parity checks, being set to “01” to indicate 11-20 as the number of parity checks, being set to “10” to indicate 21-30 as the number of parity checks, and being set to “11” to cover the else situation (e.g., a number of parity checks >30). As another non-limiting example where four parity bits are included in the set of parity bits, the two bits being set to “00” may indicate one as the number of parity checks, being set to “01” may indicate two as the number of parity checks, being set to “10” may indicate three as the number of parity checks, and being set to “11” may indicate four as the number of parity checks. Other examples of the set of indicator values may also be used to signal the number/ratio of parity checks that pass/fail the parity check. Accordingly, the set of indicator values may provide an association between quantization levels and the number of transmitted parity bits.

As discussed above, the additional information may signal a preferred MCS and/or an estimated SNR/BLER. In this example, the set of indicator values may correspond to different MCS values, SNR values, or BLER values. As network device 205 and UE 210 have negotiated the quantization levels/values for the additional information, network device 205 will know how to appropriately interpret the additional information carried or otherwise conveyed in the feedback message.

Accordingly, network device 205 may receive the feedback message that carries or otherwise conveys the feedback status (e.g., ACK/NACK) for the downlink transmission (e.g., PDCCH and/or PDSCH) in addition to the additional information based on the number/ratio of parity checks for parity bits that fail/pass the parity check procedures. Network device 205 may identify or otherwise determine an MCS for communications (e.g., retransmissions of the downlink transmission and/or for other downlink transmissions) with UE 210 based on the feedback message.

For example, network device 205 may recover the number of parity checks (e.g., the actual number and/or ratio) that have failed/passed the parity check procedure. Based on the number of parity checks carried in the additional information, network device 205 may identify the highest MCS that can be used for communications with UE 210 (e.g., achieves a very low or zero count as the number of parity checks that fail the parity check procedure). As another example, network device 205 may recover a BLER from the additional information carried in the feedback message. Network device 205 may correlate the BLER indication to an MCS table to identify or otherwise determine the highest MCS to be used for the channel. As another example, network device 205 may recover an MCS from the additional information carried in the feedback message. Network device 205 may use the indicated MCS as the MCS for communicating with UE 210.

Accordingly, network device 205 and UE 210 may use the feedback status indicator (e.g., the ACK/NACK indication) carried in the feedback message along with the additional information associated with the number of parity checks (e.g., the number/ratio of parity checks that pass or fail the parity check procedures) to improve MCS selection for communications between network device 205 and UE 210. Although these techniques are generally described within the context of a cellular communication link (e.g., a Uu interface), it is to be understood that these techniques may also be applicable within the context of sidelink communications (e.g., a PC5 interface) performed via physical sidelink channel(s). Within the context of a sidelink interface, references to network device 205 and/or UE 210 may include a sidelink UE. The techniques described herein may also be equally applicable within the context of a relay network (e.g., such as an integrated access and backhaul (IAB) network). Within the context of a relay network, references to a network device 205 and/or UE 210 may include a relay node, an IAB node, customer-premise equipment (CPE), or any network node within wireless communication system 200.

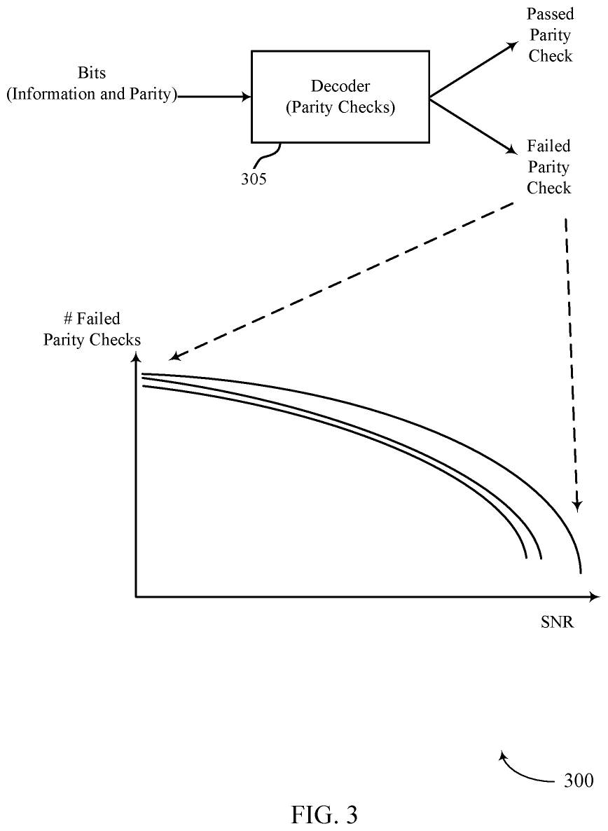

FIG. 3 illustrates an example of a decoding configuration 300 that supports methods to compute an SNR estimate for a transport block in accordance with aspects of the present disclosure. Decoding configuration 300 may implement aspects of wireless communication systems 100 and/or 200. Aspects of decoding configuration 300 may be implemented at or implemented by decoder 305, which may be a function/component of a UE as described herein.

As discussed above, aspects of the described techniques may include the network device performing a downlink transmission to a UE (e.g., a PDCCH and/or PDSCH transmission). The downlink transmission (e.g., a transport block) may include a set of parity bits in addition to information bits (e.g., control and/or data bits). The UE may use the parity bits (e.g., using decoder 305) when attempting to receive and decode the downlink transmission. For example, the UE may iteratively feed the bits of the downlink transmission (including the set of parity bits) into decoder 305, which includes components/logic that perform parity checks using the parity bits to confirm that the information bits were successfully decoded. If the parity check procedure passes, the information bits can be considered successfully received and decoded. If the parity check procedure fails, the information bits can be considered unsuccessfully received and decoded.

Based on the results of the parity check procedures, the UE may identify or otherwise determine the number of parity checks of the set of parity bits that either pass or fail the parity check procedure. For example, the number of parity checks may correspond to the number of parity checks that fail the parity check procedure, the number of parity checks that pass the parity check procedure, a ratio of parity checks that pass to those that fail the parity check procedure, a ratio of parity checks that pass or fail the parity check procedure to the total number of parity bits in the downlink transmission.

The UE may also identify or otherwise determine a feedback status indicator for the downlink transmission. Broadly, the feedback status indicator may include ACK or NACK information based on whether or not the UE is able to successfully receive and decode the downlink transmission. Generally, the feedback status indicator may be based on the number of parity checks (e.g., failed parity checks may indicate that the UE was unable to successfully receive and decode the downlink transmission). The UE may transmit a feedback message to the network device that carries or otherwise conveys an indication of the feedback status indicator.

The feedback message may also include additional information that is based at least in part on the number of parity checks. For example, the additional information carried or otherwise conveyed in the feedback message may include an indication of, or information associated with (such as the indicator values), the number/ratio of parity checks that pass/fail the parity check procedure. Other examples of the additional information may include an estimated SNR/BLER, a highest MCS. Decoding configuration 300 illustrates an example of how the number of parity checks may be correlated to an SNR, although similar techniques may be applicable to the estimated BLER or the highest MCS. In other examples, multiple tables may be used, with a first table that correlates the number of parity checks to SNR, a second table that correlates the SNR (or BLER) to the highest MCS.

For example, the UE and/or network device may use the chart illustrated in FIG. 3 to correlate the number of parity checks (e.g., such as the number of parity checks that failed the parity check procedure) to an SNR for the channel. This may enable the UE and/or network device to determine a better understanding of the CSI for the channel based on the parity check procedures used to attempt to decode and recover the information from the downlink transmission. For example, the UE and/or network device may identify a curve (with three curves being shown by way of example only) on the chart that most closely corresponds to the highest MCS (e.g., to use fewer resource blocks) that results in an acceptable error rate. Based on the highest MCS corresponding to the number of parity checks, the network device may select the MCS to use for retransmissions of the downlink transmission to the UE and/or for other downlink transmissions to the UE.

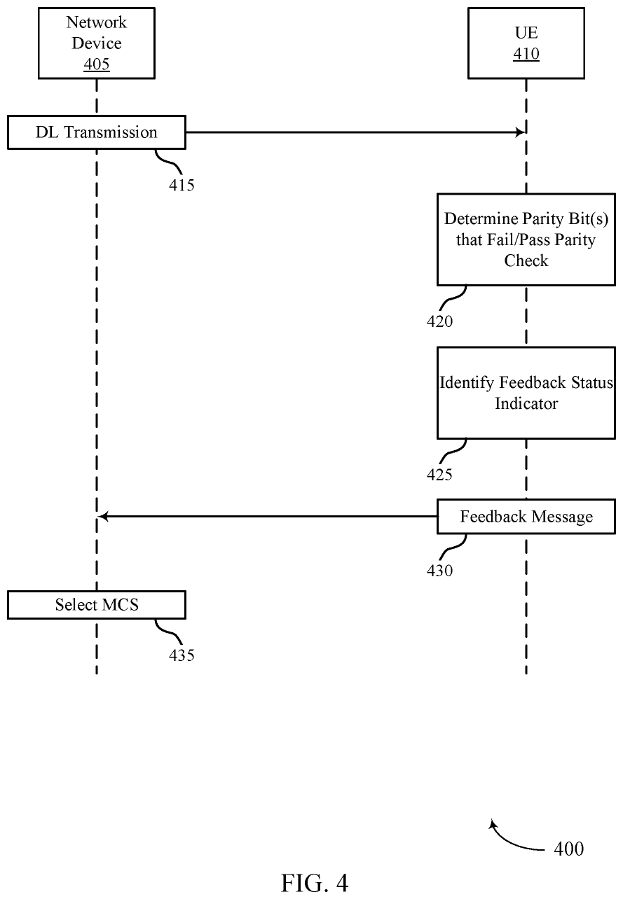

FIG. 4 illustrates an example of a process 400 that supports methods to compute an SNR estimate for a transport block in accordance with aspects of the present disclosure. Process 400 may implement aspects of wireless communication systems 100 and/or 200 and/or decoding configuration 300. Aspects of process 400 may be implemented by and/or implemented at network device 405 and/or UE 410, which may be examples of corresponding devices described herein.

At 415, network device 405 may transmit or otherwise provide (and UE 410 may monitor for, receive, or otherwise obtain) a downlink transmission that includes a set of parity bits. The downlink transmission may correspond to a PDCCH transmission and/or a PDSCH transmission.

At 420, UE 410 may identify or otherwise determine, e.g., based on the monitoring, a number of parity checks on the set of parity bits that pass or fail a parity check procedure. For example, UE 410 may perform one or more iterations of the parity check procedure on the set of parity bits of the downlink transmission. UE 410 may identify or otherwise determine the number of parity checks after each iteration, after a final iteration, and/or after some intermediate iteration of the parity check procedure.

Broadly, the number of parity checks may include the number of parity checks that satisfy the parity check procedure, a number parity checks that fail the parity check procedure, a ratio of parity checks that satisfy the parity check procedure to parity checks that fail the parity check procedure, a ratio of parity checks that fail the parity check procedure to a total number of parity checks for the downlink transmission.

At 425, UE 410 may identify or otherwise determine a feedback status indicator for the downlink transmission. Broadly, the feedback status indicator may be based on the number of parity checks and may indicate whether UE 410 was able to successfully receive and decode the downlink transmission. For example, the feedback status indicator may indicate ACK information if UE 410 was able to successfully receive and decode the downlink transmission (e.g., at least a threshold number of parity checks pass the parity check procedures). The feedback status indicator may indicate NACK information if UE 410 was unable to successfully receive and decode the downlink transmission (e.g., the threshold number of successful parity checks is not reached). UE 410 may successfully or unsuccessfully receive and decode the downlink transmission based on the parity check procedures performed on the downlink transmission using the parity bits in the set of parity bits. Accordingly, the feedback status indicator may be based on the number of parity checks determined at 420.

At 430, UE 410 may transmit or otherwise provide (and network device 405 may receive or otherwise obtain) a feedback message that includes the feedback status indicator as well as additional information that is based on the number of parity checks. For example, the additional information carried or otherwise conveyed in the feedback message may include an indication of the parity checks the satisfy the parity check procedure, an indication of parity checks that failed the parity check procedure, a ratio of parity checks that fail to those that pass the parity check procedure, a ratio of parity checks that fail the parity check procedure to the total number of parity check procedures performed, and/or a ratio of parity checks that pass the parity check procedure to the total number of parity check procedures performed.

In some examples, the additional information carried in the feedback message may simply include the number parity checks. In another example, UE 410 may map the number of parity checks to an SNR associated with the channel used for the downlink transmission. Based on the SNR, UE 410 may identify an MCS, with the MCS being indicated as the additional information in the feedback message. For example, UE 410 may correlate the number parity checks to an SNR reference (e.g., chart, such as is illustrated in FIG. 3) based on iteration(s) of the parity check procedure. For example, UE 410 may identify the highest MCS supported by the SNR and indicate the highest MCS as the additional information in the feedback message.

At 435, network device 405 may identify or otherwise select an MCS for communications with UE 410 based on the feedback message. For example, if the feedback status indicator indicates ACK information, network device 405 may continue to use the current MCS for communications with UE 410. However, if the feedback status indicator indicates NACK information, network device 405 may identify a different MCS to use for communications with UE 410. In the situation where the additional information includes the number of parity checks, this may include network device 405 correlating the number parity checks to an SNR/BLER, and then selecting the MCS based on the correlated SNR/BLER. In the situation where the additional information includes the SNR/BLER, network device 405 may select the MCS based on the correlation between the SNR and an MCS. In situation where the additional information includes an MCS, network device 405 may use the indicated MCS as the updated MCS for communications with UE 410. The communications with 410 in this context may include a retransmission of the original downlink transmission and/or may include subsequent downlink transmissions to UE 410.

Accordingly, network device 405 and UE 410 may use the feedback status indicator in connection with the additional information that is based on the number of parity checks to improve MCS/resource selection/allocation decisions. This may reduce latency and improve reliability for communications between network device 405 and UE 410.

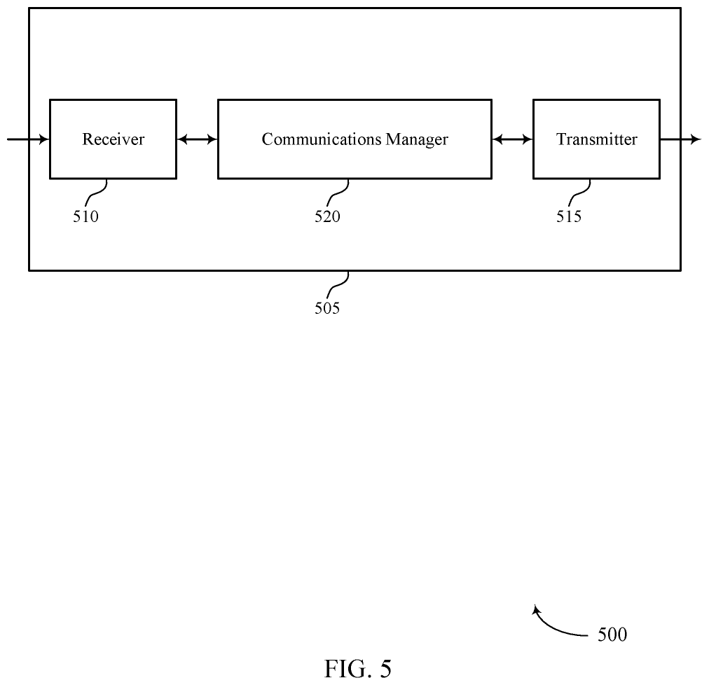

FIG. 5 shows a block diagram 500 of a device 505 that supports methods to compute an SNR estimate for a transport block in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to methods to compute an SNR estimate for a transport block). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to methods to compute an SNR estimate for a transport block). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of methods to compute an SNR estimate for a transport block as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a central processing unit (CPU), a graphics processing unit (GPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for monitoring for a downlink transmission from a network device, the downlink transmission including a set of parity bits. The communications manager 520 may be configured as or otherwise support a means for determining, based on the monitoring, a number of parity checks of the set of parity bits that either failed a parity check procedure or satisfied the parity check procedure. The communications manager 520 may be configured as or otherwise support a means for identifying, based on the monitoring and the number of parity checks, a feedback status indicator for the downlink transmission. The communications manager 520 may be configured as or otherwise support a means for transmitting a feedback message that includes the feedback status indicator and additional information based on the number of parity checks.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for utilizing the results of the parity check procedures in the decoder as additional information signaled to the network device to improve MCS/resource selection/allocation.

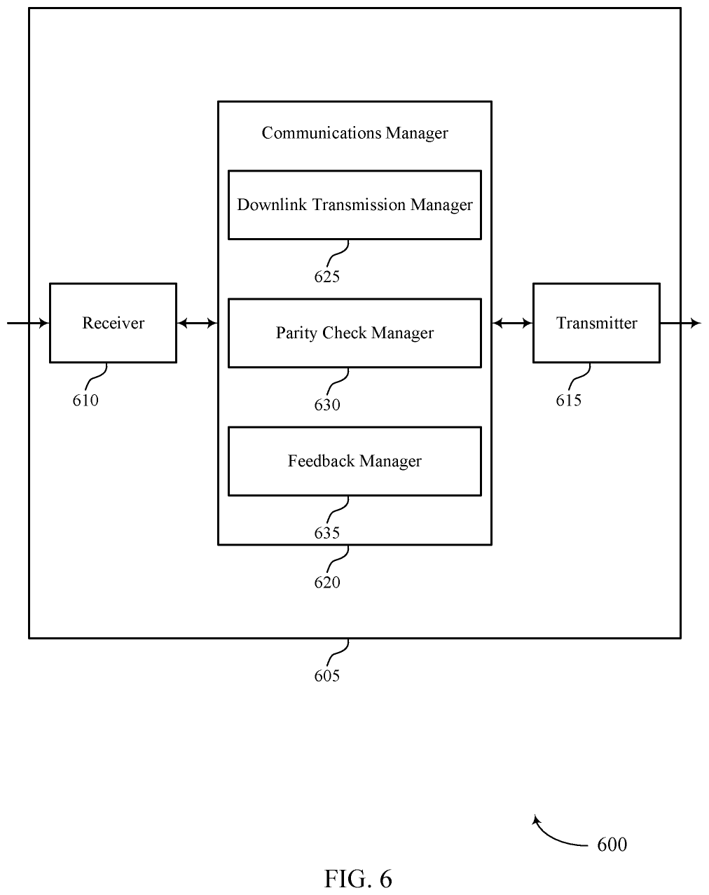

FIG. 6 shows a block diagram 600 of a device 605 that supports methods to compute an SNR estimate for a transport block in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to methods to compute an SNR estimate for a transport block). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to methods to compute an SNR estimate for a transport block). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of methods to compute an SNR estimate for a transport block as described herein. For example, the communications manager 620 may include a downlink transmission manager 625, a parity check manager 630, a feedback manager 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The downlink transmission manager 625 may be configured as or otherwise support a means for monitoring for a downlink transmission from a network device, the downlink transmission including a set of parity bits. The parity check manager 630 may be configured as or otherwise support a means for determining, based on the monitoring, a number of parity checks of the set of parity bits that either failed a parity check procedure or satisfied the parity check procedure. The feedback manager 635 may be configured as or otherwise support a means for identifying, based on the monitoring and the number of parity checks, a feedback status indicator for the downlink transmission. The feedback manager 635 may be configured as or otherwise support a means for transmitting a feedback message that includes the feedback status indicator and additional information based on the number of parity checks.

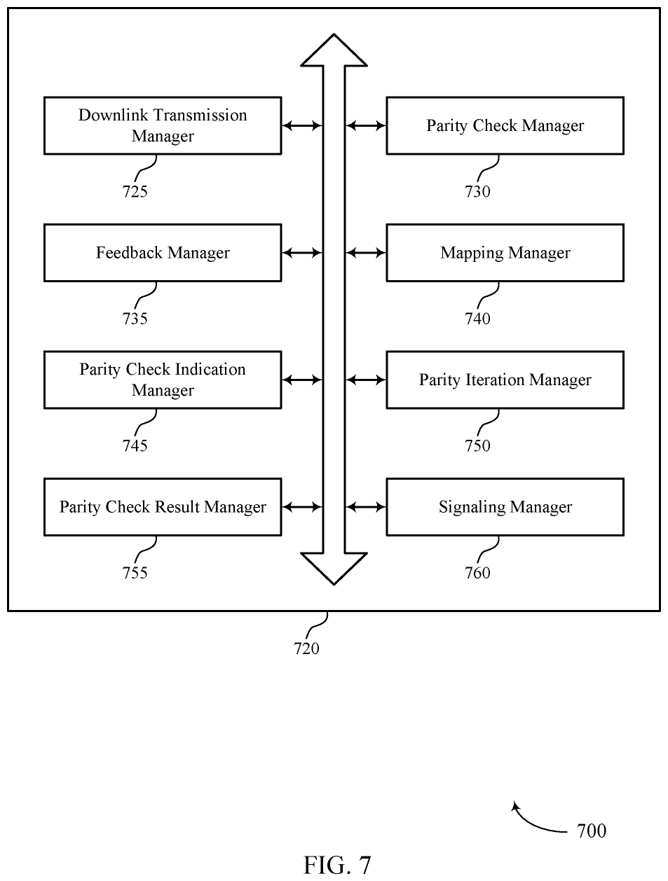

FIG. 7 shows a block diagram 700 of a communications manager 720 that supports methods to compute an SNR estimate for a transport block in accordance with aspects of the present disclosure. The communications manager 720 may be an example of aspects of a communications manager 520, a communications manager 620, or both, as described herein. The communications manager 720, or various components thereof, may be an example of means for performing various aspects of methods to compute an SNR estimate for a transport block as described herein. For example, the communications manager 720 may include a downlink transmission manager 725, a parity check manager 730, a feedback manager 735, a mapping manager 740, a parity check indication manager 745, a parity iteration manager 750, a parity check result manager 755, a signaling manager 760, or any combination thereof. Each of these components may communicate, directly or indirectly, with one another (e.g., via one or more buses).

The communications manager 720 may support wireless communication at a UE in accordance with examples as disclosed herein. The downlink transmission manager 725 may be configured as or otherwise support a means for monitoring for a downlink transmission from a network device, the downlink transmission including a set of parity bits. The parity check manager 730 may be configured as or otherwise support a means for determining, based on the monitoring, a number of parity checks of the set of parity bits that either failed a parity check procedure or satisfied the parity check procedure. The feedback manager 735 may be configured as or otherwise support a means for identifying, based on the monitoring and the number of parity checks, a feedback status indicator for the downlink transmission. In some examples, the feedback manager 735 may be configured as or otherwise support a means for transmitting a feedback message that includes the feedback status indicator and additional information based on the number of parity checks.

In some examples, the mapping manager 740 may be configured as or otherwise support a means for mapping the number of parity checks to an SNR associated with a channel used for the downlink transmission. In some examples, the mapping manager 740 may be configured as or otherwise support a means for identifying a modulation and coding scheme based on the SNR, where the additional information in the feedback message is the modulation and coding scheme.

In some examples, to support mapping the number of parity checks, the mapping manager 740 may be configured as or otherwise support a means for correlating the number of parity checks to an SNR reference based on one or more iterations of the parity check procedure. In some examples, to support identifying the modulation and coding scheme, the mapping manager 740 may be configured as or otherwise support a means for identifying a highest modulation and coding scheme supported by the SNR. In some examples, to support identifying the modulation and coding scheme, the mapping manager 740 may be configured as or otherwise support a means for identifying an estimated block error rate for the downlink transmission based on the number of parity checks.

In some examples, the parity check indication manager 745 may be configured as or otherwise support a means for including the number of parity checks as the additional information in the feedback message.

In some examples, the parity iteration manager 750 may be configured as or otherwise support a means for performing one or more iterations of the parity check procedure on the set of parity bits of the downlink transmission. In some examples, the parity iteration manager 750 may be configured as or otherwise support a means for identifying the number of parity checks after each iteration of the parity check procedure.

In some examples, the parity iteration manager 750 may be configured as or otherwise support a means for identifying the number of parity checks after a final iteration of the parity check procedure. In some examples, the parity iteration manager 750 may be configured as or otherwise support a means for identifying the number of parity checks at an intermediate iteration of the parity check procedure.

In some examples, the parity check result manager 755 may be configured as or otherwise support a means for identifying the number of parity checks based on the parity checks that satisfied the parity check procedure. In some examples, the parity check result manager 755 may be configured as or otherwise support a means for identifying the number of parity checks based on the parity checks that failed the parity check procedure.

In some examples, the parity check result manager 755 may be configured as or otherwise support a means for identifying the number of parity checks based on a ratio of parity checks that satisfied the parity check procedure to parity checks that failed the parity check procedure. In some examples, the parity check result manager 755 may be configured as or otherwise support a means for identifying the number of parity checks based on a ratio of parity checks that satisfied the parity check procedure to a total number of parity checks for the downlink transmission. In some examples, the parity check result manager 755 may be configured as or otherwise support a means for identifying the number of parity checks based on a ratio of parity checks that failed the parity check procedure to a total number of parity checks for the downlink transmission.

In some examples, the parity check result manager 755 may be configured as or otherwise support a means for identifying the number of parity checks based at least in part on a number of layers, a TBS, a target BLER, or any combination thereof, associated with the downlink transmission. In some examples, the downlink transmission comprises a cellular-based downlink transmission (e.g., a Uu interface based transmission) received from a network device or a sidelink-based downlink transmission (e.g., a PC5 interface based transmission) received from a neighboring UE (e.g., a sidelink UE within a threshold range).

In some examples, the signaling manager 760 may be configured as or otherwise support a means for identifying, based on signaling exchanged with the network device, a set of indicator values associated with the number of parity checks. In some examples, the set of indicator values include indicator values corresponding to a quantization of the number of parity checks.

In some examples, the signaling manager 760 may be configured as or otherwise support a means for receiving an indication of the set of indicator values from the network device using at least one of RRC signaling, a MAC CE message, a DCI message, a UE-assistance information message, or a combination thereof.

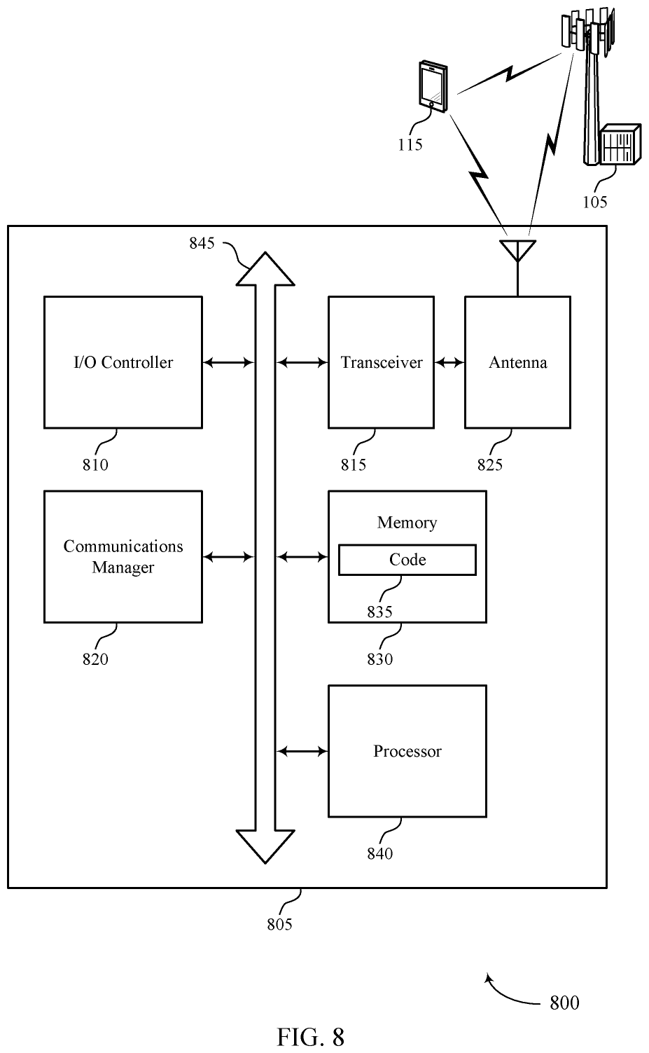

FIG. 8 shows a diagram of a system 800 including a device 805 that supports methods to compute an SNR estimate for a transport block in accordance with aspects of the present disclosure. The device 805 may be an example of or include the components of a device 505, a device 605, or a UE 115 as described herein. The device 805 may communicate wirelessly with one or more network devices 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting methods to compute an SNR estimate for a transport block). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for monitoring for a downlink transmission from a network device, the downlink transmission including a set of parity bits. The communications manager 820 may be configured as or otherwise support a means for determining, based on the monitoring, a number of parity checks of the set of parity bits that either failed a parity check procedure or satisfied the parity check procedure. The communications manager 820 may be configured as or otherwise support a means for identifying, based on the monitoring and the number of parity checks, a feedback status indicator for the downlink transmission. The communications manager 820 may be configured as or otherwise support a means for transmitting a feedback message that includes the feedback status indicator and additional information based on the number of parity checks.

By including or configuring the communications manager 820 in accordance with examples as described herein, the device 805 may support techniques for utilizing the results of the parity check procedures in the decoder as additional information signaled to the network device to improve MCS/resource selection/allocation.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of methods to compute an SNR estimate for a transport block as described herein, or the processor 840 and the memory 830 may be otherwise configured to perform or support such operations.

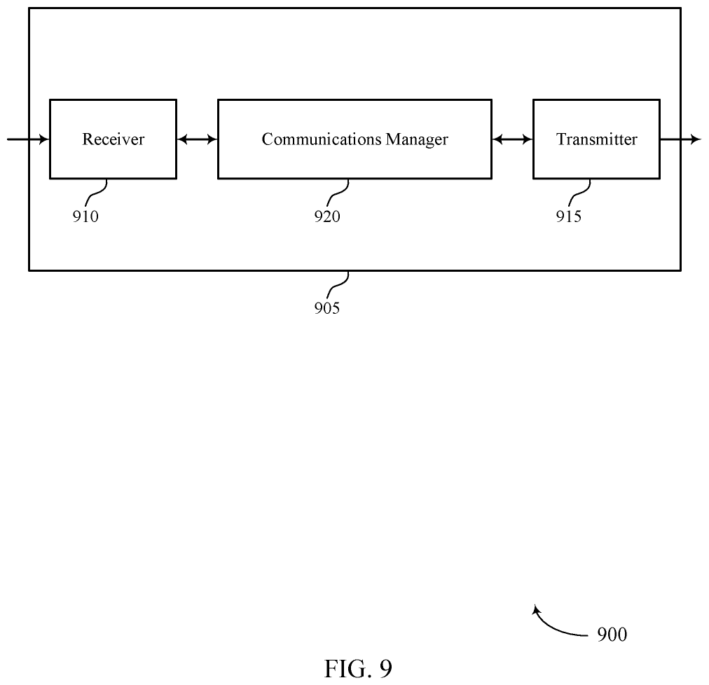

FIG. 9 shows a block diagram 900 of a device 905 that supports methods to compute an SNR estimate for a transport block in accordance with aspects of the present disclosure. The device 905 may be an example of aspects of a network device 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to methods to compute an SNR estimate for a transport block). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to methods to compute an SNR estimate for a transport block). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of methods to compute an SNR estimate for a transport block as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a network device in accordance with examples as disclosed herein. For example, the communications manager 920 may be configured as or otherwise support a means for transmitting, to a UE, a downlink transmission that includes a set of parity bits. The communications manager 920 may be configured as or otherwise support a means for receiving a feedback message from the UE that includes a feedback status indicator and additional information based on a number of parity checks associated with the set of parity bits, the number of parity checks being based on parity checks of the set of parity bits that either failed a parity check procedure or satisfied the parity check procedure. The communications manager 920 may be configured as or otherwise support a means for selecting a modulation and coding scheme for communications with the UE based on the feedback message.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for utilizing the results of the parity check procedures in the decoder as additional information signaled to the network device to improve MCS/resource selection/allocation.

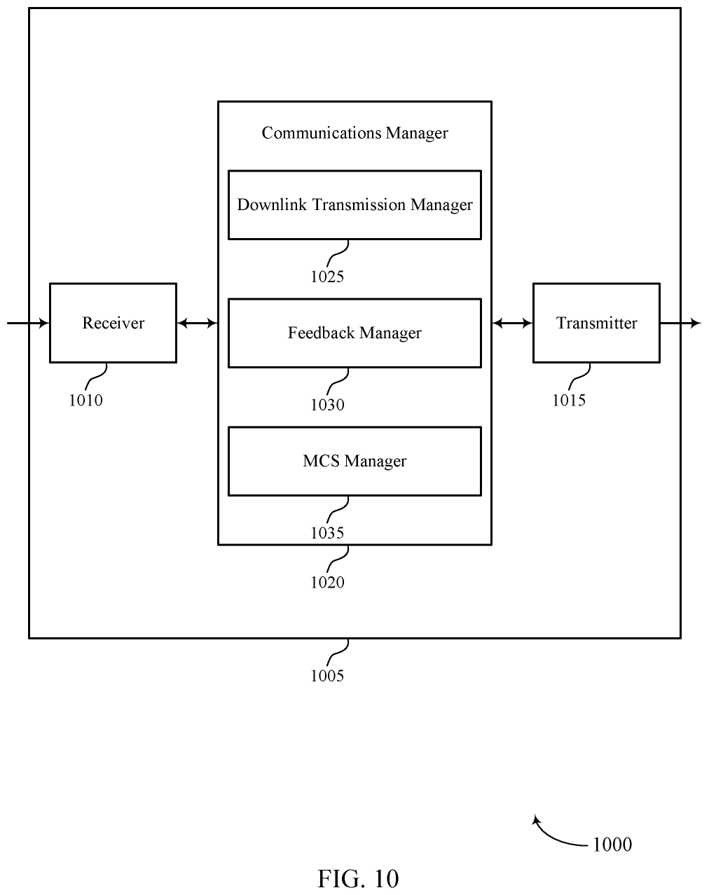

FIG. 10 shows a block diagram 1000 of a device 1005 that supports methods to compute an SNR estimate for a transport block in accordance with aspects of the present disclosure. The device 1005 may be an example of aspects of a device 905 or a network device 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to methods to compute an SNR estimate for a transport block). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to methods to compute an SNR estimate for a transport block). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of methods to compute an SNR estimate for a transport block as described herein. For example, the communications manager 1020 may include a downlink transmission manager 1025, a feedback manager 1030, an MCS manager 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network device in accordance with examples as disclosed herein. The downlink transmission manager 1025 may be configured as or otherwise support a means for transmitting, to a UE, a downlink transmission that includes a set of parity bits. The feedback manager 1030 may be configured as or otherwise support a means for receiving a feedback message from the UE that includes a feedback status indicator and additional information based on a number of parity checks associated with the set of parity bits, the number of parity checks being based on parity checks of the set of parity bits that either failed a parity check procedure or satisfied the parity check procedure. The MCS manager 1035 may be configured as or otherwise support a means for selecting a modulation and coding scheme for communications with the UE based on the feedback message.

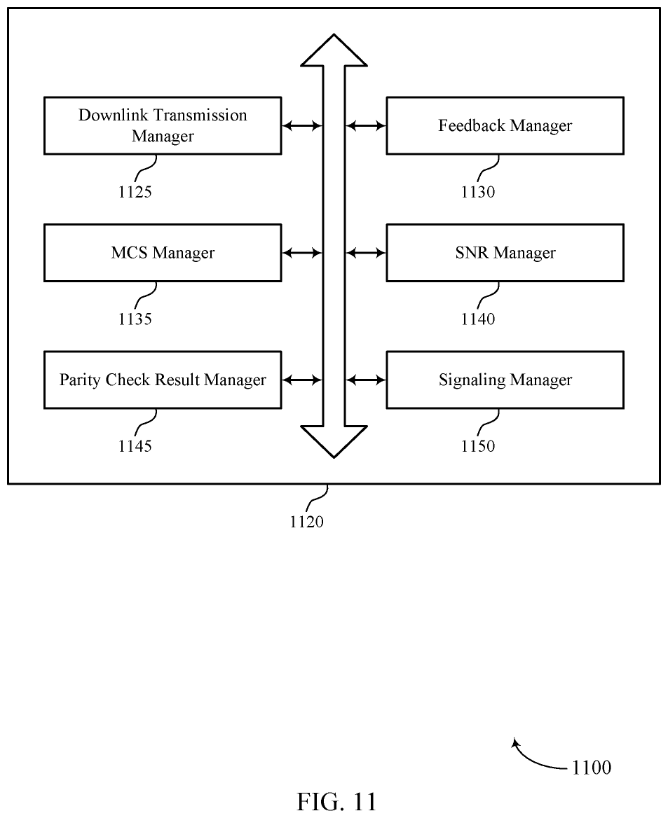

FIG. 11 shows a block diagram 1100 of a communications manager 1120 that supports methods to compute an SNR estimate for a transport block in accordance with aspects of the present disclosure. The communications manager 1120 may be an example of aspects of a communications manager 920, a communications manager 1020, or both, as described herein. The communications manager 1120, or various components thereof, may be an example of means for performing various aspects of methods to compute an SNR estimate for a transport block as described herein. For example, the communications manager 1120 may include a downlink transmission manager 1125, a feedback manager 1130, an MCS manager 1135, an SNR manager 1140, a parity check result manager 1145, a signaling manager 1150, or any combination thereof. Each of these components may communicate, directly or indirectly, with one another (e.g., via one or more buses).

The communications manager 1120 may support wireless communication at a network device in accordance with examples as disclosed herein. The downlink transmission manager 1125 may be configured as or otherwise support a means for transmitting, to a UE, a downlink transmission that includes a set of parity bits. The feedback manager 1130 may be configured as or otherwise support a means for receiving a feedback message from the UE that includes a feedback status indicator and additional information based on a number of parity checks associated with the set of parity bits, the number of parity checks being based on parity checks of the set of parity bits that either failed a parity check procedure or satisfied the parity check procedure. The MCS manager 1135 may be configured as or otherwise support a means for selecting a modulation and coding scheme for communications with the UE based on the feedback message.

In some examples, the SNR manager 1140 may be configured as or otherwise support a means for identifying the modulation and coding scheme based on an SNR associated with a channel used for the downlink transmission, where the additional information in the feedback message is the modulation and coding scheme.

In some examples, the parity check result manager 1145 may be configured as or otherwise support a means for identifying the number of parity checks based on the additional information in the feedback message. In some examples, the parity check result manager 1145 may be configured as or otherwise support a means for identifying the modulation and coding scheme based on the number of parity checks.

In some examples, the number of parity checks is identified based on the parity checks that satisfied the parity check procedure. In some examples, the number of parity checks is identified based on the parity checks that failed the parity check procedure. In some examples, the number of parity checks is identified based on a ratio of parity checks that satisfied the parity check procedure to parity checks that failed the parity check procedure. In some examples, the number of parity checks is identified based on a ratio of parity checks that satisfied the parity check procedure to a total number of parity checks for the downlink transmission. In some examples, the number of parity checks is identified based on a ratio of parity checks that failed the parity check procedure to a total number of parity checks for the downlink transmission.

In some examples, the signaling manager 1150 may be configured as or otherwise support a means for identifying, based on signaling exchanged with the UE, a set of indicator values associated with the number of parity checks. In some examples, the set of indicator values include indicator values corresponding to a quantization of the number of parity checks. In some examples, the signaling manager 1150 may be configured as or otherwise support a means for transmitting an indication of the set of indicator values to the UE using at least one of RRC signaling, a medium access control (MAC) control element (CE) message, a DCI message, a UE-assistance information message, or a combination thereof.

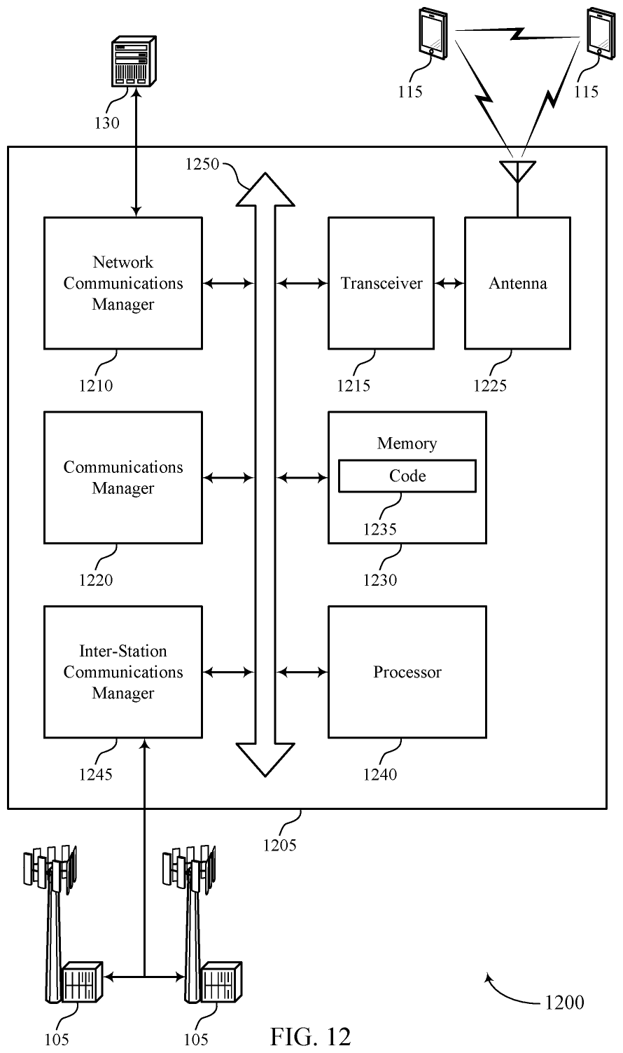

FIG. 12 shows a diagram of a system 1200 including a device 1205 that supports methods to compute an SNR estimate for a transport block in accordance with aspects of the present disclosure. The device 1205 may be an example of or include the components of a device 905, a device 1005, or a network device 105 as described herein. The device 1205 may communicate wirelessly with one or more network devices 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting methods to compute an SNR estimate for a transport block). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other network devices 105, and may include a controller or scheduler for controlling communications with UEs 115 in cooperation with other network devices 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between network devices 105.

The communications manager 1220 may support wireless communication at a network device in accordance with examples as disclosed herein. For example, the communications manager 1220 may be configured as or otherwise support a means for transmitting, to a UE, a downlink transmission that includes a set of parity bits. The communications manager 1220 may be configured as or otherwise support a means for receiving a feedback message from the UE that includes a feedback status indicator and additional information based on a number of parity checks associated with the set of parity bits, the number of parity checks being based on parity checks of the set of parity bits that either failed a parity check procedure or satisfied the parity check procedure. The communications manager 1220 may be configured as or otherwise support a means for selecting a modulation and coding scheme for communications with the UE based on the feedback message.

By including or configuring the communications manager 1220 in accordance with examples as described herein, the device 1205 may support techniques for utilizing the results of the parity check procedures in the decoder as additional information signaled to the network device to improve MCS/resource selection/allocation.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of methods to compute an SNR estimate for a transport block as described herein, or the processor 1240 and the memory 1230 may be otherwise configured to perform or support such operations.

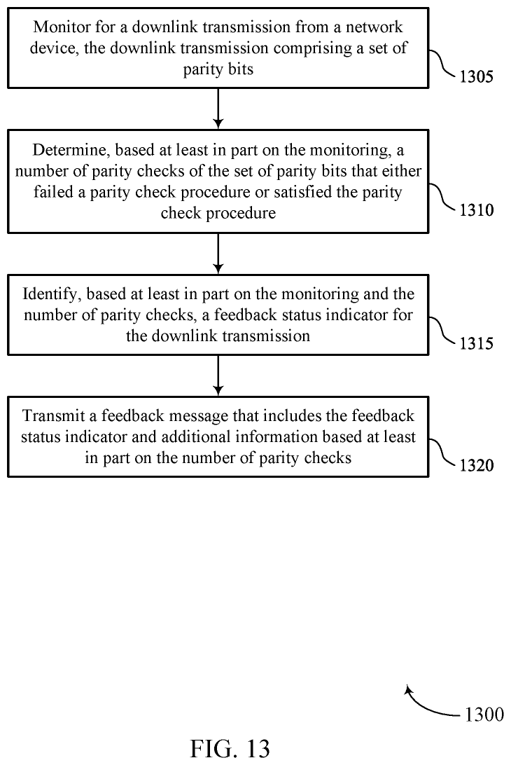

FIG. 13 shows a flowchart illustrating a method 1300 that supports methods to compute an SNR estimate for a transport block in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include monitoring for a downlink transmission from a network device, the downlink transmission including a set of parity bits. The operations of 1305 may be performed in accordance with examples as disclosed herein. In some examples, aspects of the operations of 1305 may be performed by a downlink transmission manager 725 as described with reference to FIG. 7.

At 1310, the method may include determining, based on the monitoring, a number of parity checks of the set of parity bits that either failed a parity check procedure or satisfied the parity check procedure. The operations of 1310 may be performed in accordance with examples as disclosed herein. In some examples, aspects of the operations of 1310 may be performed by a parity check manager 730 as described with reference to FIG. 7.

At 1315, the method may include identifying, based on the monitoring and the number of parity checks, a feedback status indicator for the downlink transmission. The operations of 1315 may be performed in accordance with examples as disclosed herein. In some examples, aspects of the operations of 1315 may be performed by a feedback manager 735 as described with reference to FIG. 7.

At 1320, the method may include transmitting a feedback message that includes the feedback status indicator and additional information based on the number of parity checks. The operations of 1320 may be performed in accordance with examples as disclosed herein. In some examples, aspects of the operations of 1320 may be performed by a feedback manager 735 as described with reference to FIG. 7.

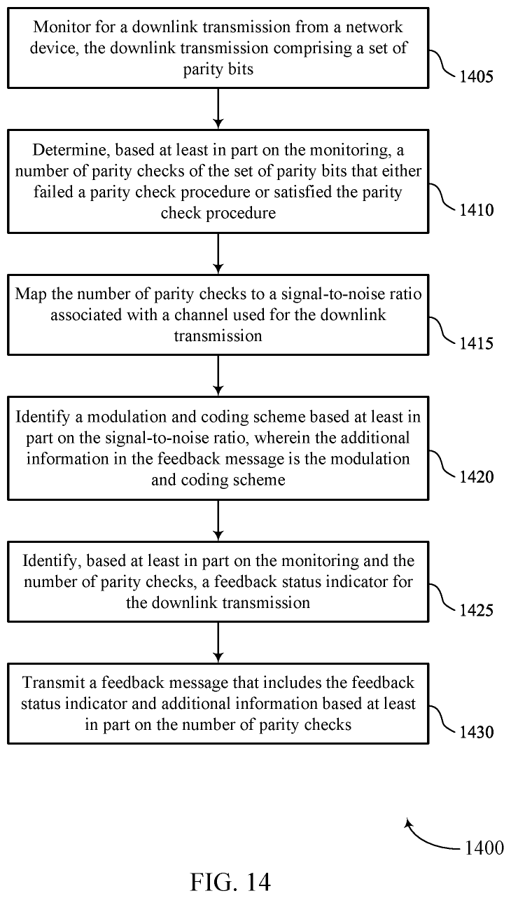

FIG. 14 shows a flowchart illustrating a method 1400 that supports methods to compute an SNR estimate for a transport block in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include monitoring for a downlink transmission from a network device, the downlink transmission including a set of parity bits. The operations of 1405 may be performed in accordance with examples as disclosed herein. In some examples, aspects of the operations of 1405 may be performed by a downlink transmission manager 725 as described with reference to FIG. 7.

At 1410, the method may include determining, based on the monitoring, a number of parity checks of the set of parity bits that either failed a parity check procedure or satisfied the parity check procedure. The operations of 1410 may be performed in accordance with examples as disclosed herein. In some examples, aspects of the operations of 1410 may be performed by a parity check manager 730 as described with reference to FIG. 7.

At 1415, the method may include mapping the number of parity checks to an SNR associated with a channel used for the downlink transmission. The operations of 1415 may be performed in accordance with examples as disclosed herein. In some examples, aspects of the operations of 1415 may be performed by a mapping manager 740 as described with reference to FIG. 7.

At 1420, the method may include identifying a modulation and coding scheme based on the SNR, where the additional information in the feedback message is the modulation and coding scheme. The operations of 1420 may be performed in accordance with examples as disclosed herein. In some examples, aspects of the operations of 1420 may be performed by a mapping manager 740 as described with reference to FIG. 7.

At 1425, the method may include identifying, based on the monitoring and the number of parity checks, a feedback status indicator for the downlink transmission. The operations of 1425 may be performed in accordance with examples as disclosed herein. In some examples, aspects of the operations of 1425 may be performed by a feedback manager 735 as described with reference to FIG. 7.

At 1430, the method may include transmitting a feedback message that includes the feedback status indicator and additional information based on the number of parity checks. The operations of 1430 may be performed in accordance with examples as disclosed herein. In some examples, aspects of the operations of 1430 may be performed by a feedback manager 735 as described with reference to FIG. 7.

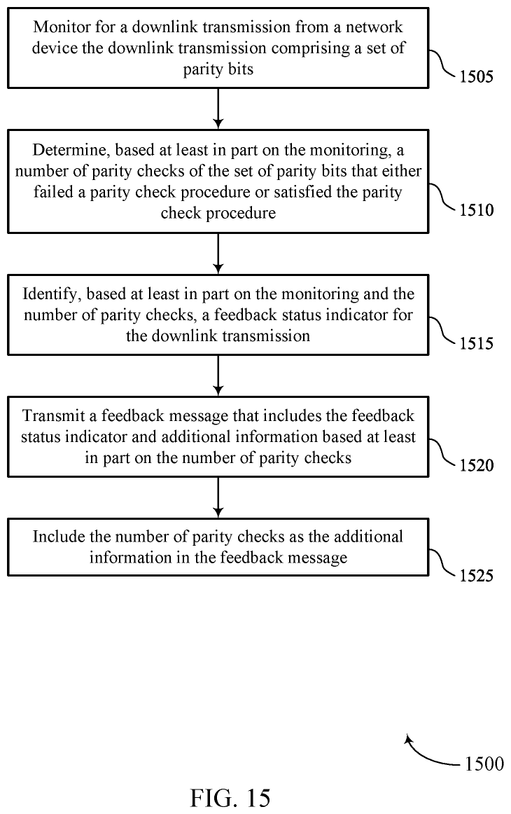

FIG. 15 shows a flowchart illustrating a method 1500 that supports methods to compute an SNR estimate for a transport block in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include monitoring for a downlink transmission from a network device, the downlink transmission including a set of parity bits. The operations of 1505 may be performed in accordance with examples as disclosed herein. In some examples, aspects of the operations of 1505 may be performed by a downlink transmission manager 725 as described with reference to FIG. 7.

At 1510, the method may include determining, based on the monitoring, a number of parity checks of the set of parity bits that either failed a parity check procedure or satisfied the parity check procedure. The operations of 1510 may be performed in accordance with examples as disclosed herein. In some examples, aspects of the operations of 1510 may be performed by a parity check manager 730 as described with reference to FIG. 7.

At 1515, the method may include identifying, based on the monitoring and the number of parity checks, a feedback status indicator for the downlink transmission. The operations of 1515 may be performed in accordance with examples as disclosed herein. In some examples, aspects of the operations of 1515 may be performed by a feedback manager 735 as described with reference to FIG. 7.

At 1520, the method may include transmitting a feedback message that includes the feedback status indicator and additional information based on the number of parity checks. The operations of 1520 may be performed in accordance with examples as disclosed herein. In some examples, aspects of the operations of 1520 may be performed by a feedback manager 735 as described with reference to FIG. 7.

At 1525, the method may include including the number of parity checks as the additional information in the feedback message. The operations of 1525 may be performed in accordance with examples as disclosed herein. In some examples, aspects of the operations of 1525 may be performed by a parity check indication manager 745 as described with reference to FIG. 7.

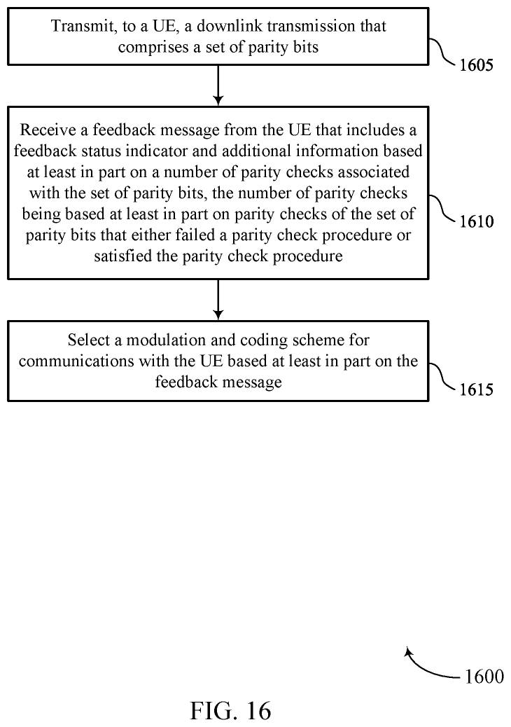

FIG. 16 shows a flowchart illustrating a method 1600 that supports methods to compute an SNR estimate for a transport block in accordance with aspects of the present disclosure. The operations of the method 1600 may be implemented by a network device or its components as described herein. For example, the operations of the method 1600 may be performed by a network device 105 as described with reference to FIGS. 1 through 4 and 9 through 12. In some examples, a network device may execute a set of instructions to control the functional elements of the network device to perform the described functions. Additionally, or alternatively, the network device may perform aspects of the described functions using special-purpose hardware.

At 1605, the method may include transmitting, to a UE, a downlink transmission that includes a set of parity bits. The operations of 1605 may be performed in accordance with examples as disclosed herein. In some examples, aspects of the operations of 1605 may be performed by a downlink transmission manager 1125 as described with reference to FIG. 11.

At 1610, the method may include receiving a feedback message from the UE that includes a feedback status indicator and additional information based on a number of parity checks associated with the set of parity bits, the number of parity checks being based on parity checks of the set of parity bits that either failed a parity check procedure or satisfied the parity check procedure. The operations of 1610 may be performed in accordance with examples as disclosed herein. In some examples, aspects of the operations of 1610 may be performed by a feedback manager 1130 as described with reference to FIG. 11.

At 1615, the method may include selecting a modulation and coding scheme for communications with the UE based on the feedback message. The operations of 1615 may be performed in accordance with examples as disclosed herein. In some examples, aspects of the operations of 1615 may be performed by an MCS manager 1135 as described with reference to FIG. 11.

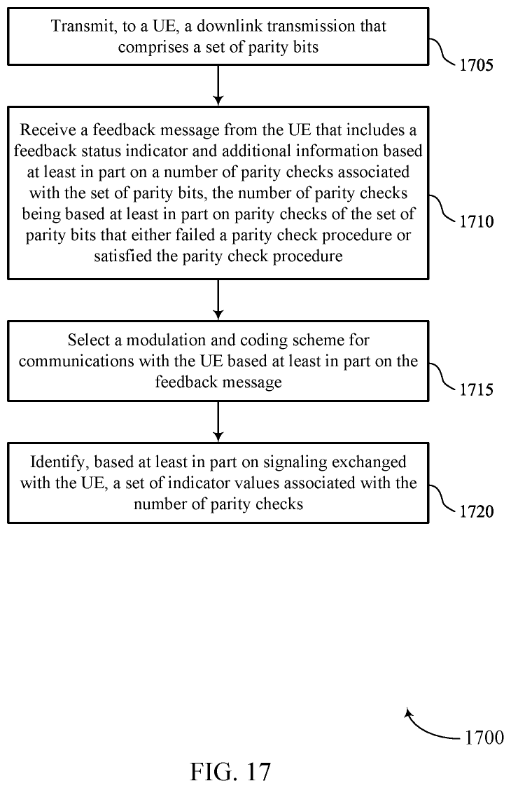

FIG. 17 shows a flowchart illustrating a method 1700 that supports methods to compute an SNR estimate for a transport block in accordance with aspects of the present disclosure. The operations of the method 1700 may be implemented by a network device or its components as described herein. For example, the operations of the method 1700 may be performed by a network device 105 as described with reference to FIGS. 1 through 4 and 9 through 12. In some examples, a network device may execute a set of instructions to control the functional elements of the network device to perform the described functions. Additionally, or alternatively, the network device may perform aspects of the described functions using special-purpose hardware.

At 1705, the method may include transmitting, to a UE, a downlink transmission that includes a set of parity bits. The operations of 1705 may be performed in accordance with examples as disclosed herein. In some examples, aspects of the operations of 1705 may be performed by a downlink transmission manager 1125 as described with reference to FIG. 11.

At 1710, the method may include receiving a feedback message from the UE that includes a feedback status indicator and additional information based on a number of parity checks associated with the set of parity bits, the number of parity checks being based on parity checks of the set of parity bits that either failed a parity check procedure or satisfied the parity check procedure. The operations of 1710 may be performed in accordance with examples as disclosed herein. In some examples, aspects of the operations of 1710 may be performed by a feedback manager 1130 as described with reference to FIG. 11.

At 1715, the method may include selecting a modulation and coding scheme for communications with the UE based on the feedback message. The operations of 1715 may be performed in accordance with examples as disclosed herein. In some examples, aspects of the operations of 1715 may be performed by an MCS manager 1135 as described with reference to FIG. 11.

At 1720, the method may include identifying, based on signaling exchanged with the UE, a set of indicator values associated with the number of parity checks. The operations of 1720 may be performed in accordance with examples as disclosed herein. In some examples, aspects of the operations of 1720 may be performed by a signaling manager 1150 as described with reference to FIG. 11.

The following provides an overview of aspects of the present disclosure:
Aspect 1: A method for wireless communication at a UE, comprising: monitoring for a downlink transmission from a network device, the downlink transmission comprising a set of parity bits; determining, based at least in part on the monitoring, a number of parity checks of the set of parity bits that either failed a parity check procedure or satisfied the parity check procedure; identifying, based at least in part on the monitoring and the number of parity checks, a feedback status indicator for the downlink transmission; and transmitting a feedback message that includes the feedback status indicator and additional information based at least in part on the number of parity checks.
Aspect 2: The method of aspect 1, further comprising: mapping the number of parity checks to a SNR associated with a channel used for the downlink transmission; and identifying a MCS scheme based at least in part on the SNR, wherein the additional information in the feedback message is the MCS scheme.
Aspect 3: The method of aspect 2, wherein mapping the number of parity checks comprises: correlating the number of parity checks to a SNR reference based at least in part on one or more iterations of the parity check procedure.
Aspect 4: The method of any of aspects 2 through 3, wherein identifying the MCS scheme comprises: identifying a highest available MCS scheme supported by the SNR.
Aspect 5: The method of any of aspects 2 through 4, wherein identifying the MCS scheme comprises: identifying an estimated block error rate for the downlink transmission based at least in part on the number of parity checks.
Aspect 6: The method of any of aspects 1 through 5, further comprising: including the number of parity checks as the additional information in the feedback message.
Aspect 7: The method of any of aspects 1 through 6, further comprising: performing one or more iterations of the parity check procedure on the set of parity bits of the downlink transmission.
Aspect 8: The method of aspect 7, further comprising: identifying the number of parity checks after each iteration of the parity check procedure.
Aspect 9: The method of any of aspects 7 through 8, further comprising: identifying the number of parity checks after a final iteration of the parity check procedure.
Aspect 10: The method of any of aspects 7 through 9, further comprising: identifying the number of parity checks at an intermediate iteration of the parity check procedure.
Aspect 11: The method of any of aspects 1 through 10, further comprising: identifying the number of parity checks based at least in part on the parity checks that satisfied the parity check procedure.
Aspect 12: The method of any of aspects 1 through 11, further comprising: identifying the number of parity checks based at least in part on the parity checks that failed the parity check procedure.
Aspect 13: The method of any of aspects 1 through 12, further comprising: identifying the number of parity checks based at least in part on a ratio of parity checks that satisfied the parity check procedure to parity checks that failed the parity check procedure.
Aspect 14: The method of any of aspects 1 through 13, further comprising: identifying the number of parity checks based at least in part on a ratio of parity checks that satisfied the parity check procedure to a total number of parity checks for the downlink transmission.
Aspect 15: The method of any of aspects 1 through 14, further comprising: identifying the number of parity checks based at least in part on a ratio of parity checks that failed the parity check procedure to a total number of parity checks for the downlink transmission.
Aspect 16: The method of any of aspects 1 through 15, further comprising: identifying, based at least in part on signaling exchanged with the network device, a set of indicator values associated with the number of parity checks.
Aspect 17: The method of aspect 16, wherein the set of indicator values comprise indicator values corresponding to a quantization of the number of parity checks.
Aspect 18: The method of any of aspects 16 through 17, further comprising: receiving an indication of the set of indicator values from the network device using at least one of RRC signaling, a MAC CE message, a DCI message, a UE-assistance information message, or a combination thereof
Aspect 19: The method of any of aspects 16 through 17, further comprising: identifying the number of parity checks based at least in part on a number of layers, a TBS, a target BLER, or any combination thereof, associated with the downlink transmission.
Aspect 20: The method of any of aspects 16 through 17, wherein the downlink transmission comprises a cellular-based downlink transmission received from a network device or a sidelink-based downlink transmission received from a neighboring UE.
Aspect 21: A method for wireless communication at a network device, comprising: transmitting, to a UE, a downlink transmission that comprises a set of parity bits; receiving a feedback message from the UE that includes a feedback status indicator and additional information based at least in part on a number of parity checks associated with the set of parity bits, the number of parity checks being based at least in part on parity checks of the set of parity bits that either failed a parity check procedure or satisfied the parity check procedure; and selecting a MCS scheme for communications with the UE based at least in part on the feedback message.
Aspect 22: The method of aspect 21, further comprising: identifying the MCS scheme based at least in part on a SNR associated with a channel used for the downlink transmission, wherein the additional information in the feedback message is the MCS scheme.
Aspect 23: The method of any of aspects 21 through 22, further comprising: identifying the number of parity checks based at least in part on the additional information in the feedback message; and identifying the MCS scheme based at least in part on the number of parity checks.
Aspect 24: The method of any of aspects 21 through 23, wherein the number of parity checks is identified based at least in part on the parity checks that satisfied the parity check procedure.
Aspect 25: The method of any of aspects 21 through 24, wherein the number of parity checks is identified based at least in part on the parity checks that failed the parity check procedure.
Aspect 26: The method of any of aspects 21 through 25, wherein the number of parity checks is identified based at least in part on a ratio of parity checks that satisfied the parity check procedure to parity checks that failed the parity check procedure.
Aspect 27: The method of any of aspects 21 through 26, wherein the number of parity checks is identified based at least in part on a ratio of parity checks that satisfied the parity check procedure to a total number of parity checks for the downlink transmission.
Aspect 28: The method of any of aspects 21 through 27, wherein the number of parity checks is identified based at least in part on a ratio of parity checks that failed the parity check procedure to a total number of parity checks for the downlink transmission.
Aspect 29: The method of any of aspects 21 through 28, further comprising: identifying, based at least in part on signaling exchanged with the UE, a set of indicator values associated with the number of parity checks.
Aspect 30: The method of aspect 29, wherein the set of indicator values comprise indicator values corresponding to a quantization of the number of parity checks.
Aspect 31: The method of any of aspects 29 through 30, further comprising: transmitting an indication of the set of indicator values to the UE using at least one of RRC signaling, a MAC CE message, a DCI message, a UE-assistance information message, or a combination thereof
Aspect 32: An apparatus for wireless communication at a UE, comprising at least one processor; memory coupled with the at least one processor; and instructions stored in the memory and executable by the at least one processor to cause the apparatus to perform a method of any of aspects 1 through 20.
Aspect 33: An apparatus for wireless communication at a UE, comprising at least one means for performing a method of any of aspects 1 through 20.
Aspect 34: A non-transitory computer-readable medium storing code for wireless communication at a UE, the code comprising instructions executable by at least one processor to perform a method of any of aspects 1 through 20.
Aspect 35: An apparatus for wireless communication at a network device, comprising at least one processor; memory coupled with the at least one processor; and instructions stored in the memory and executable by the at least one processor to cause the apparatus to perform a method of any of aspects 21 through 31.
Aspect 36: An apparatus for wireless communication at a network device, comprising at least one means for performing a method of any of aspects 21 through 31.
Aspect 37: A non-transitory computer-readable medium storing code for wireless communication at a network device, the code comprising instructions executable by at least one processor to perform a method of any of aspects 21 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), or ascertaining. Also, “determining” can include receiving (such as receiving information), or accessing (such as accessing data in a memory). Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
at least one processor;
memory coupled to the at least one processor; and
instructions stored in the memory and executable by the at least one processor to cause the apparatus to:
monitor for a downlink transmission from a network device, the downlink transmission comprising a set of parity bits;
determine, based at least in part on the monitoring, a number of parity checks of the set of parity bits that either failed a parity check procedure or satisfied the parity check procedure;
identify, based at least in part on the monitoring and the number of parity checks, a feedback status indicator for the downlink transmission; and
transmit a feedback message that includes the feedback status indicator and additional information identifying the number of parity checks.

2. The apparatus of claim 1, wherein the instructions are further executable by the at least one processor to cause the apparatus to:
map the number of parity checks to a signal-to-noise ratio associated with a channel used for the downlink transmission; and
identify a modulation and coding scheme based at least in part on the signal-to-noise ratio, wherein the additional information in the feedback message further identifies the modulation and coding scheme.

3. The apparatus of claim 2, wherein the instructions to map the number of parity checks are executable by the at least one processor to cause the apparatus to:
correlate the number of parity checks to a signal-to-noise ratio reference based at least in part on one or more iterations of the parity check procedure.

4. The apparatus of claim 2, wherein the instructions to identify the modulation and coding scheme are executable by the at least one processor to cause the apparatus to:
identify a highest modulation and coding scheme supported by the signal-to-noise ratio.

5. The apparatus of claim 2, wherein the instructions to identify the modulation and coding scheme are executable by the at least one processor to cause the apparatus to:
identify an estimated block error rate for the downlink transmission based at least in part on the number of parity checks.

6. (canceled)

7. The apparatus of claim 1, wherein the instructions are further executable by the at least one processor to cause the apparatus to:
perform one or more iterations of the parity check procedure on the set of parity bits of the downlink transmission.

8. The apparatus of claim 7, wherein the instructions are further executable by the at least one processor to cause the apparatus to:
identify the number of parity checks after each iteration of the parity check procedure.

9. The apparatus of claim 7, wherein the instructions are further executable by the at least one processor to cause the apparatus to:
identify the number of parity checks after a final iteration of the parity check procedure.

10. The apparatus of claim 7, wherein the instructions are further executable by the at least one processor to cause the apparatus to:
identify the number of parity checks at an intermediate iteration of the parity check procedure.

11. The apparatus of claim 1, wherein the instructions are further executable by the at least one processor to cause the apparatus to:
identify the number of parity checks based at least in part on parity checks that satisfied the parity check procedure.

12. The apparatus of claim 1, wherein the instructions are further executable by the at least one processor to cause the apparatus to:
identify the number of parity checks based at least in part on parity checks that failed the parity check procedure.

13. The apparatus of claim 1, wherein the instructions are further executable by the at least one processor to cause the apparatus to:
identify the number of parity checks based at least in part on a ratio of parity checks that satisfied the parity check procedure to parity checks that failed the parity check procedure.

14. The apparatus of claim 1, wherein the instructions are further executable by the at least one processor to cause the apparatus to:
identify the number of parity checks based at least in part on a ratio of parity checks that satisfied the parity check procedure to a total number of parity checks for the downlink transmission.

15. The apparatus of claim 1, wherein the instructions are further executable by the at least one processor to cause the apparatus to:
identify the number of parity checks based at least in part on a ratio of parity checks that failed the parity check procedure to a total number of parity checks for the downlink transmission.

16. The apparatus of claim 1, wherein the instructions are further executable by the at least one processor to cause the apparatus to:
identify, based at least in part on signaling exchanged with the network device, a set of indicator values associated with the number of parity checks.

17. The apparatus of claim 16, wherein the set of indicator values comprise indicator values corresponding to a quantization of the number of parity checks.

18. The apparatus of claim 16, wherein the instructions are further executable by the at least one processor to cause the apparatus to:
receive an indication of the set of indicator values from the network device using at least one of radio resource control (RRC) signaling, a medium access control (MAC) control element (CE) message, a downlink control information (DCI) message, a UE-assistance information message, or a combination thereof.

19. The apparatus of claim 1, wherein the instructions are further executable by the at least one processor to cause the apparatus to:
identify the number of parity checks based at least in part on a number of layers, a transport-block size (TBS), a target block level error rate (BLER), or any combination thereof, associated with the downlink transmission.

20. The apparatus of claim 1, wherein the downlink transmission comprises a cellular-based downlink transmission received from a network device or a sidelink-based downlink transmission received from a neighboring UE.

21. An apparatus for wireless communication at a network device, comprising:
at least one processor;
memory coupled to the at least one processor; and
instructions stored in the memory and executable by the at least one processor to cause the apparatus to:
transmit, to a user equipment (UE), a downlink transmission that comprises a set of parity bits;
receive a feedback message from the UE that includes a feedback status indicator and additional information identifying a number of parity checks associated with the set of parity bits, the number of parity checks being based at least in part on parity checks of the set of parity bits that either failed a parity check procedure or satisfied the parity check procedure; and
select a modulation and coding scheme for communications with the UE based at least in part on the feedback message.

22. The apparatus of claim 21, wherein the instructions are further executable by the at least one processor to cause the apparatus to:
identify the modulation and coding scheme based at least in part on a signal-to-noise ratio associated with a channel used for the downlink transmission, wherein the additional information in the feedback message further identifies the modulation and coding scheme.

23. The apparatus of claim 21, wherein the instructions are further executable by the at least one processor to cause the apparatus to:
identify the modulation and coding scheme based at least in part on the number of parity checks.

24. The apparatus of claim 21, wherein the number of parity checks is identified based at least in part on parity checks that satisfied the parity check procedure.

25. The apparatus of claim 21, wherein the number of parity checks is identified based at least in part on the parity checks that failed the parity check procedure.

26. The apparatus of claim 21, wherein the number of parity checks is identified based at least in part on a ratio of parity checks that satisfied the parity check procedure to parity checks that failed the parity check procedure.

27. The apparatus of claim 21, wherein the number of parity checks is identified based at least in part on a ratio of parity checks that satisfied the parity check procedure to a total number of parity checks for the downlink transmission.

28. The apparatus of claim 21, wherein the number of parity checks is identified based at least in part on a ratio of parity checks that failed the parity check procedure to a total number of parity checks for the downlink transmission.

29. A method for wireless communication at a user equipment (UE), comprising:
monitoring for a downlink transmission from a network device, the downlink transmission comprising a set of parity bits;
determining, based at least in part on the monitoring, a number of parity checks of the set of parity bits that either failed a parity check procedure or satisfied the parity check procedure;
identifying, based at least in part on the monitoring and the number of parity checks, a feedback status indicator for the downlink transmission; and
transmitting a feedback message that includes the feedback status indicator and additional information identifying the number of parity checks.

30. A method for wireless communication at a network device, comprising:
transmitting, to a user equipment (UE), a downlink transmission that comprises a set of parity bits;
receiving a feedback message from the UE that includes a feedback status indicator and additional information identifying a number of parity checks associated with the set of parity bits, the number of parity checks being based at least in part on parity checks of the set of parity bits that either failed a parity check procedure or satisfied the parity check procedure; and
selecting a modulation and coding scheme for communications with the UE based at least in part on the feedback message.
